(19) United States
(12) Patent Application Publication
(10) Pub. No.: US 2026/0072319 A1
(43) Pub. Date: Mar. 12, 2026

(54) DISPLAY DEVICE AND DISPLAY PANEL

(71) Applicant: LG DISPLAY CO., LTD., Seoul (KR)

(72) Inventors: Jeon Phill HAN, Paju-si (KR); Seung Han PAEK, Paju-si (KR); Dae Hyun NAM, Paju-si (KR); Gyu Sik WON, Paju-si (KR)

(73) Assignee: LG DISPLAY CO., LTD., Seoul (KR)

(21) Appl. No.: 19/284,270

(22) Filed: Jul. 29, 2025

(30) Foreign Application Priority Data
Sep. 11, 2024 (KR) 10-2024-0124156

(51) Int. Cl. G02F 1/1362; G02F 1/1368

(52) U.S. Cl. CPC G02F 1/136286; G02F 1/1368

(57) ABSTRACT

A display device according to one or more examples may include a display panel including a groove and a circuit board connected to the display panel, and the display panel may include: a substrate including a first substrate and a second substrate spaced apart from each other by the groove; a circuit layer arranged on the first substrate and including a transistor; a planarization layer arranged on the first substrate and the groove; a pad portion arranged on the second substrate and connected to the circuit board; a bending wire arranged on the planarization layer; and a connection wire connected to the bending wire.

### CROSS-REFERENCE TO RELATED APPLICATIONS

This application claims the benefit of and priority to Korean Patent Application No. 10-2024-0124156, filed Sep. 11, 2024, the entire contents of which are incorporated herein by reference for all purposes as if fully set forth herein.

### BACKGROUND

### 1. Technical Field

Embodiments relates to a display panel and a display device including the same and more specifically, for example, without limitation, to a display panel including a substrate to which an etching process is applied for manufacturing process optimization, and a display device including the same.

### 2. Description of Related Art

A flexible display may change a screen size by rolling, folding, or bending a flexible panel. The flexible display may be implemented as a rollable display, a foldable display, a bendable display, a slidable display, etc. Such a flexible display may be used and included not only in mobile devices such as smartphones and tablet PCs, but also in televisions, vehicle displays, wearable devices, etc., and their application fields are expanding.

The flexible display may implement a bezel bended display with a minimized bezel area by folding a non-display area using a flexible panel structure.

The description provided in the description of related art section should not be assumed to be prior art merely because it is mentioned in or associated with the description of related art section. The description of related art section includes information that describes one or more aspects of the subject technology, and the description in this section does not limit the present disclosure.

### SUMMARY

It is newly recognized by the inventors of the present application that, as a bending area of the flexible display is bent, stress may be concentrated on a part of a connection wire arranged on the bending area. Therefore, cracks may occur in the connection wire. In such a case, the connection wire may be made of various metal materials in consideration of conductivity, but there are limitations in selecting the material of the connection wire in consideration of the possibility of damage to the connection wire due to bending.

In addition, it is further recognized by the inventors of the present application that the flexible display may use an etching process for process simplification, and a separate anti-etching layer is arranged for the etching process of a substrate. However, a separate mask process is required for the arrangement of the anti-etching layer, and the manufacturing productivity of a display device may decrease due to an increased number of steps or processes introduced by the mask process.

Accordingly, a display panel that may prevent damage to or minimize the possibility of damage to the connection wire due to bending while improving manufacturing productivity and a display device including the same are needed.

An example embodiment of the present disclosure provides a display panel including a substrate subjected to an etching process for the purpose of manufacturing process optimization, and a display device including the same.

An example embodiment of the present disclosure provides a display panel using a partial component arranged in a display area as an anti-etching layer for manufacturing process simplification and a display device including the same.

An example embodiment of the present disclosure provides a display panel that prevents damage to, or minimizes the possibility of damage to, a connection wire from bending by using a bending wire arranged in a bending area and a display device including the same.

An example embodiment of the present disclosure provides a display device including a narrow bezel, where providing a structurally improved substrate to a pad portion and bending the substrate enable the bezel to be narrow.

The aspects of the present disclosure are not limited to those mentioned above, and other aspects not explicitly stated will be readily understood by those skilled in the art from the present disclosure.

A display device according to one example embodiment of the present disclosure includes a display panel that includes: a groove; a substrate including a first substrate and a second substrate spaced apart from each other by the groove; a circuit layer arranged on the first substrate and including a transistor; a planarization layer arranged on the first substrate and the groove; a pad portion arranged on the second substrate; a bending wire arranged on the planarization layer; and a connection wire connected to the bending wire.

According to one or more aspects of the present disclosure, process optimization can be achieved using an etching process. For example, since a plurality of grooves corresponding to the respective grooves of a plurality of display panels can be formed on one mother substrate using an etching process, a manufacturing process may be simplified.

According to one or more aspects of the present disclosure, by using a partial component arranged in a display area as an anti-etching layer, a separate anti-etching layer is unnecessary. Therefore, since no separate mask process is needed to arrange the anti-etching layer, the manufacturing productivity of the display device can be improved.

According to one or more aspects of the present disclosure, the rigidity of a substrate may be maintained by processing a substrate made of a glass material using an etching process.

According to one or more aspects of the present disclosure, when a substrate made of a glass material is etched, damage to a bending wire arranged in a bending area may be prevented by using a planarization layer made of an organic material.

According to one or more aspects of the present disclosure, a bending wire may be protected using a pattern layer arranged on a bending wire.

Various advantages and effects of the embodiments of the present disclosure are not limited to those described above, and other advantages and effects will be readily understood by those skilled in the art from the present disclosure.

The effects of the embodiments of the present disclosure are not limited to those described above, and other effects are included in the present disclosure.

Additional features and aspects of the present disclosure are set forth in part in the description that follows and in part will become apparent from the present disclosure or may be learned by practice of the inventive concepts provided herein. Other features and aspects of the present disclosure may be realized and attained by the descriptions provided in the present disclosure, or derivable therefrom, and the claims hereof as well as the drawings. It is intended that all such features and aspects be included within this description, be within the scope of the present disclosure, and be protected by the following claims. Nothing in this section should be taken as a limitation on those claims. Further features and aspects are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure. In the drawings:

FIG. 1 is a perspective view showing a display device according to one example embodiment of the present disclosure;

FIG. 2 is a plan view showing a display device according to one example embodiment of the present disclosure;

FIG. 3 is an example cross-sectional view taken along line I-I′ in FIG. 2;

FIG. 4 is an example enlarged view showing an area A in FIG. 3;

FIGS. 5A to 5D are views showing a manufacturing process of a display panel according to one example embodiment of the present disclosure;

FIG. 6 is an example view showing a neutral plane according to bending;

FIG. 7 is a view showing a coating layer arranged on a display panel according to one example embodiment of the present disclosure;

FIG. 8 is a view showing a bent appearance of a display device according to one example embodiment of the present disclosure;

FIG. 9 is a cross-sectional view showing another embodiment of a display panel according to one example embodiment of the present disclosure;

FIG. 10 is an example enlarged view showing an area B in FIG. 9;

FIG. 11 is a view showing a bent appearance of a display device to which another embodiment of a display panel according to one example embodiment of the present disclosure is utilized;

FIG. 12 is a cross-sectional view showing another example embodiment of a display panel according to one example embodiment of the present disclosure; and

FIG. 13 is an example enlarged view showing an area C in FIG. 12.

Throughout the drawings and the detailed description, unless otherwise described, the same drawing reference numerals should be understood to refer to the same elements, features, and structures. The sizes, lengths, and thicknesses of layers, regions and elements, and depiction thereof may be exaggerated for clarity, illustration, and/or convenience.

### DETAILED DESCRIPTION

Reference is now made in detail to embodiments of the present disclosure, examples of which may be illustrated in the accompanying drawings. In the following description, when a detailed description of well-known methods, functions, structures or configurations may unnecessarily obscure aspects of the present disclosure, the detailed description thereof may have been omitted for brevity. Further, repetitive descriptions may be omitted for brevity. The progression of processing steps and/or operations described is a non-limiting example.

The sequence of steps and/or operations is not limited to that set forth herein and may be changed to occur in an order that is different from an order described herein, with the exception of steps and/or operations necessarily occurring in a particular order. In one or more examples, two operations in succession may be performed substantially concurrently, or the two operations may be performed in a reverse order or in a different order depending on a function or operation involved.

Unless stated otherwise, like reference numerals may refer to like elements throughout even when they are shown in different drawings. Unless stated otherwise, the same reference numerals may be used to refer to the same or substantially the same elements throughout the specification and the drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof, are clarified through the embodiments described with reference to the accompanying drawings. The present disclosure may, however, be embodied in different forms and should not be construed as limited to the embodiments set forth herein. Rather, these embodiments are examples and are provided so that this disclosure may be thorough and complete to assist those skilled in the art to understand the inventive concepts without limiting the protected scope of the present disclosure.

Shapes, dimensions (e.g., sizes, lengths, widths, heights, thicknesses, locations, radii, diameters, and areas), proportions, ratios, angles, numbers, the number of elements, and the like disclosed herein, including those illustrated in the drawings, are merely examples, and thus, the present disclosure is not limited to the illustrated details. It is, however, noted that the relative dimensions of the components illustrated in the drawings are part of the present disclosure.

When the term “comprise,” “have,” “include,” “contain,” “constitute,” “made of,” “formed of,” “composed of,” or the like is used with respect to one or more elements (e.g., layers, films, components, electrodes, structures, transistors, sections, members, parts, regions, areas, portions, steps, operations, and/or the like), one or more other elements may be added unless a term such as “only” or the like is used. The terms used in the present disclosure are merely used in order to describe particular example embodiments, and are not intended to limit the scope of the present disclosure. The terms of a singular form may include plural forms unless the context clearly indicates otherwise. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In one or more aspects, unless explicitly stated otherwise, an element, feature, or corresponding information (e.g., a level, range, dimension, size, or the like) is construed to include an error or tolerance range even where no explicit description of such an error or tolerance range is provided. An error or tolerance range may be caused by various factors (e.g., process factors, internal or external impact, noise, or the like). In interpreting a numerical value, the value is interpreted as including an error range unless explicitly stated otherwise.

When a positional relationship between two elements (e.g., layers, films, components, electrodes, structures, transistors, sections, members, parts, regions, areas, portions, and/or the like) are described using any of the terms such as “on,” “on a top of,” “upon,” “on top of,” “over,” “under,” “above,” “upper,” “at an upper portion,” “at a upper side,” “below,” “lower,” “at a lower portion,” “at a lower side,” “beneath,” “near,” “close to,” “adjacent to,” “beside,” “next to,” “at or on a side of,” and/or the like indicating a position or location, one or more other elements may be located between the two elements unless a more limiting term, such as “immediate(ly),” “direct(ly),” or “close(ly),” is used. For example, when an element and another element are described using any of the foregoing terms, this description should be construed as including a case in which the elements contact each other directly as well as a case in which one or more additional elements are disposed or interposed therebetween. Furthermore, the spatially relative terms such as the foregoing terms as well as other terms such as “front,” “rear,” “back,” “left,” “right,” “top,” “bottom,” “upper,” “lower,” “downward,” “upward,” “up,” “down,” “column,” “row,” “vertical,” “horizontal,” “diagonal,” and the like refer to an arbitrary frame of reference. For example, these terms may be used for an example understanding of a relative relationship between elements, including any correlation as shown in the drawings. However, embodiments of the disclosure are not limited thereby or thereto. The spatially relative terms are to be understood as terms including different orientations of the elements in use or in operation in addition to the orientation depicted in the drawings or described herein. For example, where a lower element or an element positioned under another element is overturned, then the element may be termed as an upper element or an element positioned above another element. Thus, for example, the term “under” or “beneath” may encompass, in meaning, the term “above” or “over.” An example term “below” or the like, can include all directions, including directions of “below,” “above” and diagonal directions. Likewise, an example term “above,” “on” or the like can include all directions, including directions of “above,” “on,” “below” and diagonal directions.

In describing a temporal relationship, when the temporal order is described as, for example, “after,” “following,” “subsequent,” “next,” “before,” “preceding,” “prior to,” or the like, a case that is not consecutive or not sequential may be included and thus one or more other events may occur therebetween, unless a more limiting term, such as “just,” “immediate(ly),” or “direct(ly),” is used.

It is understood that, although the terms “first,” “second,” and the like may be used herein to describe various elements (e.g., layers, films, components, electrodes, structures, transistors, sections, members, parts, regions, areas, portions, steps, operations, and/or the like), these elements should not be limited by these terms, for example, to any particular order, precedence, or number of elements. These terms are used only to distinguish one element from another. For example, a first element may denote a second element, and, similarly, a second element may denote a first element, without departing from the scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element, and the like) are not limited by ordinal numbers or the names in front of the elements. Further, a first element may include one or more first elements. Similarly, a second element or the like may include one or more second elements or the like.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

The expression that an element (e.g., layer, film, component, electrode, structure, transistor, section, member, part, region, area, portion, or the like) “is engaged” with another element may be understood, for example, as that the element may be either directly or indirectly engaged with the another element. The term “is engaged” or similar expressions may refer to a term such as “covers,” “surrounds,” “is in contact,” “overlaps,” “crosses,” “intersects,” “is connected,” “is coupled,” “is attached,” “is adhered,” “is combined,” “is linked,” “is provided,” “is disposed,” “interacts,” or the like. The engagement may involve one or more intervening elements disposed or interposed between the element and the another element, unless otherwise specified. Further, the element may be engaged at least partially or entirely (or completely) with the another element, unless otherwise specified. Further, the element may be included in at least one of two or more elements that are engaged with each other. Similarly, the another element may be included in at least one of two or more elements that are engaged with each other. When the element is engaged with the another element, at least a portion of the element may be engaged with at least a portion of the another element. The term “with another element” or similar expressions may be understood as “another element,” or “with, to, in, or on another element,” as appropriate by the context. Similarly, the term “with each other” may be understood as “each other,” or “with, to, or on each other,” as appropriate by the context.

The phrase “through” may be understood, for example, to be at least partially through or entirely through.

The terms such as a “line” or “direction” should not be interpreted only based on a geometrical relationship in which the respective lines or directions are parallel, perpendicular, diagonal, or slanted with respect to each other, and may be meant as lines or directions having wider directivities within the range within which the components of the present disclosure may operate functionally. For example, the terms “first direction,” “second direction,” and the like (or the terms such as an X-axis direction, a Y-axis direction, a Z-axis direction, a vertical direction, a planar direction, a lengthwise or length direction, a widthwise or width direction, and a height direction) should not be interpreted only based on a geometrical relationship in which the respective directions are parallel, perpendicular, diagonal, or slanted with respect to each other, and may be meant as directions having wider directivities within the range within which the components of the present disclosure may operate functionally.

The term “at least one” should be understood as including any and all combinations of one or more of the associated listed items. For example, each of the phrases “at least one of a first item, a second item, or a third item” and “at least one of a first item, a second item, and a third item” may represent (i) a combination of items provided by two or more of the first item, the second item, and the third item or (ii) only one of the first item, the second item, or the third item. Further, at least one of a plurality of elements can represent (i) one element of the plurality of elements, (ii) some elements of the plurality of elements, or (iii) all elements of the plurality of elements. Further, “at least some,” “at least some portions,” “at least a portion,” “at least one or more portions,” “at least some elements,” “one or more,” or the like of a plurality of elements can represent (i) one element of the plurality of elements, (ii) a portion of the plurality of elements, (iii) one or more portions of the plurality of elements, (iv) multiple elements of the plurality of elements, or (v) all of the plurality of elements. Moreover, “at least some,” “at least some portions,” “at least a portion,” “at least one or more portions,” or the like of an element can represent (i) a portion of the element, (ii) one or more portions of the element, (iii) the element, or (iv) all portions of the element.

The expression of a first element, a second elements “and/or” a third element should be understood as any one of the first, second and third elements or as any or all combinations of the first, second and third elements. Similar interpretations apply to the use of “and/or” with two elements or with more than three elements. By way of example, A, B and/or C may refer to only A; only B; only C; any of A, B, and C (e.g., A, B, or C); some combination of A, B, and C (e.g., A and B; A and C; or B and C); or all of A, B, and C. Furthermore, an expression “A/B” may be understood as A and/or B. For example, an expression “A/B” may refer to only A; only B; A or B; or A and B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two. Furthermore, when an element is referred to as being “between” at least two elements, the element may be the only element between the at least two elements, or one or more intervening elements may also be present.

In one or more aspects, the phrases “each other” and “one another” may be used interchangeably simply for convenience unless stated otherwise. For example, an expression “different from each other” may be understood as being different from one another. In another example, an expression “different from one another” may be understood as being different from each other. In one or more examples, the number of elements involved in the foregoing expression may be two. In one or more examples, the number of elements involved in the foregoing expression may be more than two.

In one or more aspects, the phrases “one or more among” and “one or more of” may be used interchangeably simply for convenience unless stated otherwise.

The term “or” means “inclusive or” rather than “exclusive or.” That is, unless otherwise stated or clear from the context, the expression that “x uses a or b” means any one of natural inclusive permutations. For example, “a or b” may mean “a,” “b,” or “a and b. ” For example, “a, b or c” may mean “a,” “b,” “c,” “a and b,” “b and c,” “a and c,” or “a, b and c.”

A phrase “substantially the same” or “nearly the same” may indicate a degree of being considered as being equivalent to each other taking into account minute differences due to errors in the manufacturing process.

Features of various embodiments of the present disclosure may be partially or entirely coupled to or combined with each other, may be technically associated with each other, and may be variously operated, linked or driven together in various ways. Embodiments of the present disclosure may be implemented or carried out independently of each other or may be implemented or carried out together in a co-dependent or related relationship. In one or more aspects, the components of each apparatus and device according to various embodiments of the present disclosure are operatively coupled and configured.

Unless otherwise defined, the terms (including technical and scientific terms) used herein have the same meaning as commonly understood by one of ordinary skill in the art to which example embodiments belong. It is further understood that terms, such as those defined in commonly used dictionaries, should be interpreted as having a meaning that is, for example, consistent with their meaning in the context of the relevant art and should not be interpreted in an idealized or overly formal sense unless expressly defined otherwise herein.

The terms used herein have been selected as being general in the related technical field; however, there may be other terms depending on the development and/or change of technology, convention, preference of technicians, and so on. Therefore, the terms used herein should not be understood as limiting technical ideas, but should be understood as examples of the terms for describing example embodiments.

Further, in a specific case, a term may be arbitrarily selected by an applicant, and in this case, the detailed meaning thereof is described herein. Therefore, the terms used herein should be understood based on not only the name of the terms, but also the meaning of the terms and the content hereof.

In the following description, various example embodiments of the present disclosure are described in more detail with reference to the accompanying drawings. With respect to reference numerals to elements of each of the drawings, the same or similar elements may be illustrated in other drawings, and like reference numerals refer to like elements unless stated otherwise. The same or similar elements may be denoted by the same reference numerals even though they are depicted in different drawings. Repetitive descriptions of the same or similar elements may be omitted for brevity, and the descriptions provided for elements in one or more figures may also apply to elements in other figures that use the same reference numerals unless stated otherwise. In addition, for the convenience of description, a scale, dimension, size, and thickness of each of the elements illustrated in the accompanying drawings may be different from an actual scale, dimension, size, and thickness, and thus, embodiments of the present disclosure are not limited to a scale, dimension, size, and thickness illustrated in the drawings.

A term “device” used herein may refer to a display device including a display panel and a driver for driving the display panel. Examples of the display device may include a light emitting diode (LED), and the like. In addition, examples of the device may include a notebook computer, a television, a computer monitor, an automotive device, a wearable device, and an automotive equipment device, and a set electronic device (or apparatus) or a set device (or apparatus), for example, a mobile electronic device such as a smartphone or an electronic pad, which are complete products or final products respectively including LED and the like, but embodiments of the present disclosure are not limited thereto.

A display device according to an embodiment in this disclosure may include a display device itself in a narrow sense, an application product including a display in a narrow sense, or even a set device that is an end-consumer device.

A display device according to one example embodiment of the present disclosure may be implemented as a liquid crystal display device (LCD), a plasma display panel device (PDP), a field emission display device (FED), an electroluminescence display device (ELD), an organic light emitting diode (OLED), a quantum dot display, a micro light emitting diode (LED) display, etc.

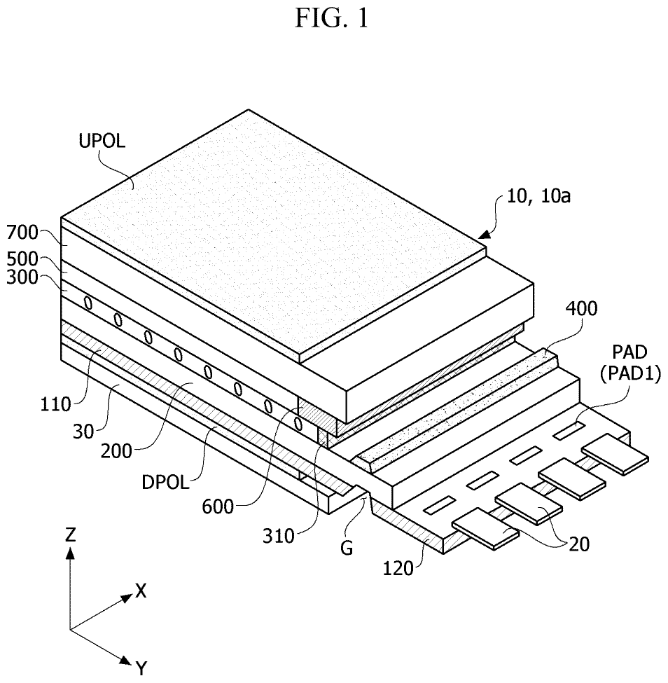

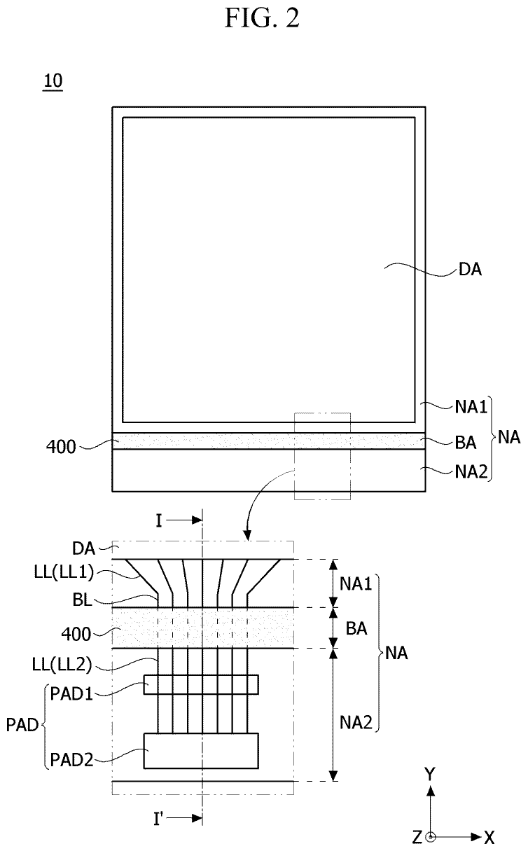

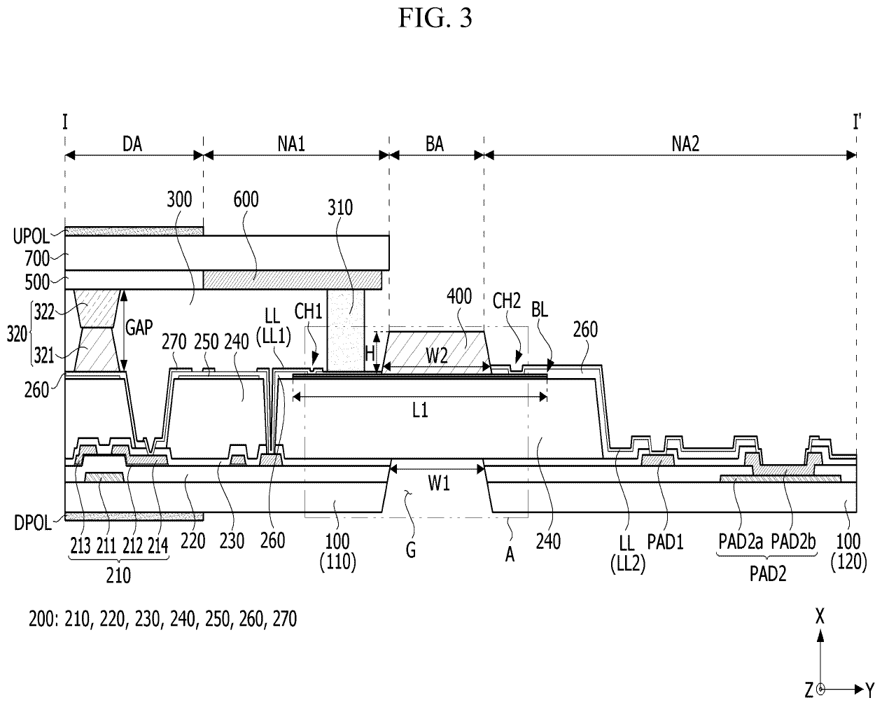

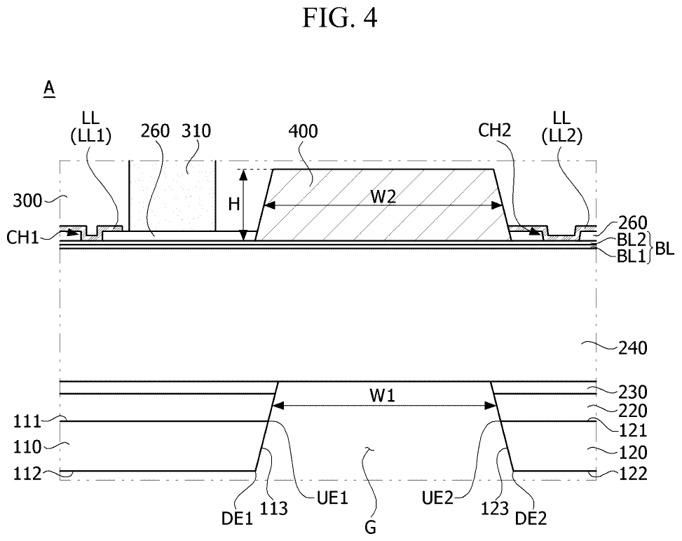

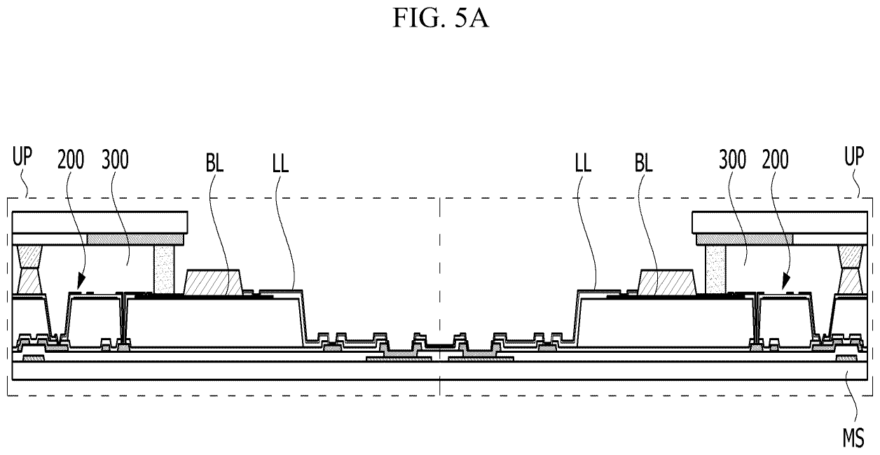

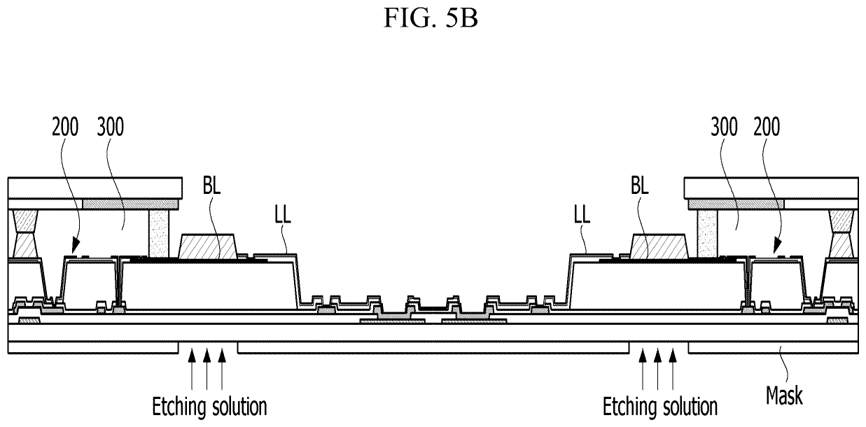

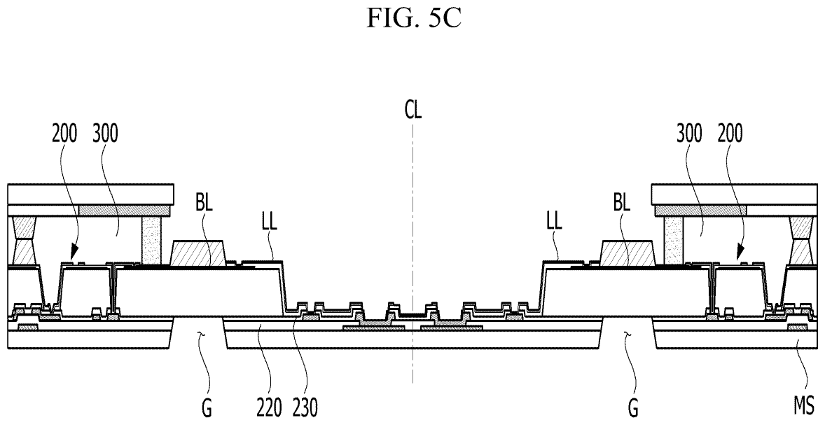

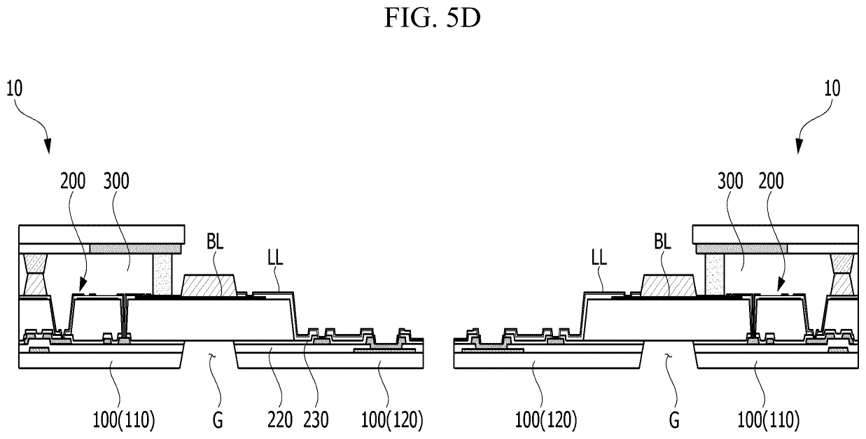

FIG. 1 is a perspective view showing a display device according to one example embodiment of the present disclosure. FIG. 2 is a plan view showing a display panel according to one example embodiment of the present disclosure. FIG. 3 is an example cross-sectional view taken along line I-I′ in FIG. 2. FIG. 4 is an example enlarged view showing an area A in FIG. 3. FIGS. 5A to 5D are views showing a manufacturing process of the display panel according to one example embodiment of the present disclosure. For example, FIG. 5A is a view showing a mother substrate MS on which a circuit layer 200, a liquid crystal layer 300, a pad portion PAD, a bending wire BL, a connection wire LL, etc., are arranged. FIG. 5B is a view showing lower etching of the mother substrate MS using a mask. FIG. 5C is a view showing a groove G formed in the mother substrate by the lower etching. FIG. 5D is a view showing a plurality of display panels 10 separated by a cutting process.

Referring to FIGS. 1 to 3, the display device according to one example embodiment of the present disclosure may include the display panel 10 including the groove G, a circuit board 20 connected to the pad portion PAD of the display panel 10, and a light source unit 30 that emits light toward the liquid crystal layer 300 of the display panel 10. In addition, an input image may be visually reproduced on the display panel 10. The light source unit 30 may be a backlight unit.

The display panel 10 may include a display area DA where an image is displayed and a non-display area NA where no image is displayed.

The non-display area NA may refer to an area outside of the display area DA. Several types of signal lines may be disposed in the non-display area NA, and several types of driving circuits may be connected thereto. At least a portion of the non-display area NA may be bent to be invisible from the front surface of the display device or may be covered by a case or housing (not shown) of the display device. The non-display area NA may be also referred to as an edge area or a bezel area.

The display panel 10 may be a panel having a rectangular structure having a width in an X-axis direction, a length in a Y-axis direction, and a thickness in a Z-axis direction. In such a case, the width and length of the display panel 10 may be set to various design values depending on the application field of the display device. The X-axis direction may mean a width direction, a row direction, or a horizontal direction, the Y-axis direction may mean a length direction, a column direction, or a vertical direction, and the Z-axis direction may mean an up-down direction, a vertical direction, or a thickness direction. The X-axis direction, the Y-axis direction, and the Z-axis direction may be perpendicular to one another, but may also mean different directions not perpendicular to one another. Therefore, each of the X-axis direction, the Y-axis direction, and the Z-axis direction may be described as any one of a first direction, a second direction, and a third direction. A plane extended in the X-axis direction and the Y-axis direction may mean a horizontal plane.

The non-display area NA may include a first non-display area NA1, a bending area BA, and a second non-display area NA2. The bending area BA may be disposed between the first non-display area NA1 and the second non-display area NA2.

The first non-display area NA1 may be an area surrounding at least a part of the display area DA.

The bending area BA is an area adjacent to at least one side among a plurality of sides of the first non-display area NA1, and may be a bendable area. The display panel 10 may be easily bent at the bending area BA. For example, the display panel 10 may be easily bent at the groove G arranged in the bending area BA.

The second non-display area NA2 is an area adjacent to at least one side among a plurality of sides of the bending area BA, and the pad portion PAD may be arranged in the second non-display area NA2. For example, the bending area BA may be in a bent state from a flat state, and the remaining area of a substrate 100 excluding the bending area BA may be in a flat state. As the bending area BA is bent, the second non-display area NA2 may be located to overlap a back surface of the display area DA. The pad portion PAD may be a pad electrode.

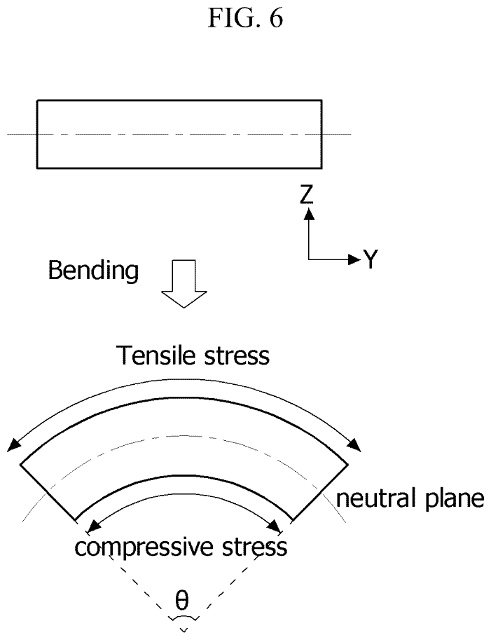

Referring to FIGS. 3 and 6, the bending area BA is located between the first non-display area NA1 and the second non-display area NA2, and various structures such as organic layers, inorganic layers, and wires arranged in the bending area BA may be bent. For example, a part of various structures such as organic layers, inorganic layers, and wires may also be bent as the bending area BA is bent.

The circuit board 20 may be a flexible printed circuit board and may be connected to the display panel 10 through the pad portion PAD, without being limited thereto.

The liquid crystal layer, etc., of the display area DA may be driven by receiving signals from one or more circuit boards 20 through the wires of the display area DA and the connection wires LL of the non-display area NA. For example, the wires of the display area DA may be wires for transmitting signals output from the circuit board 20 to the liquid crystal layer, etc., of the display area DA together with a plurality of connection wires LL.

When only the plurality of connection wires LL are arranged in the bending area BA, a part of the plurality of connection wires LL may also be bent as the bending area BA is bent. Therefore, stress may be concentrated on a part of the bent connection wires LL, and cracks may occur in the connection wires LL due to the stress.

Therefore, when the plurality of connection wires LL are arranged in the bending area BA, the possibility of damage to the connection wires LL due to cracks, etc. may be considered. As one example, the shape and material of the connection wires LL may be configured to prevent cracks that may occur in the plurality of connection wires LL during the bending of the bending area BA. For example, in order to prevent cracks that may occur in the plurality of connection wires LL during the bending of the bending area BA, the connection wire LL may be made of conductive materials having excellent ductility. In addition, the plurality of connection wires LL may be formed in various shapes in order to cope with cracks, etc. For example, at least a part of the plurality of connection wires LL arranged on the bending area BA may have a shape in which conductive patterns having at least one shape among a diamond shape, a rhombus shape, a trapezoidal wave shape, a triangular wave shape, a sawtooth wave shape, a sine wave shape, a circular shape, and an omega (Ω) shape are repeatedly arranged, without being limited thereto.

The display device according to one example embodiment of the present disclosure may stably connect the plurality of connection wires LL and the wires of the display area DA by using the bending wire BL arranged on the bending area BA.

The plurality of connection wires LL may extend from a plurality of pad portions PAD of the second non-display area NA2 toward the bending area BA. The plurality of connection wires LL may be electrically connected to the wires of the display area DA via a plurality of bending wires BL, but are not necessarily limited thereto. For example, in consideration of the stability of connection between the plurality of connection wires LL and the wires of the display area DA, the plurality of connection wires LL may be electrically connected to the wires of the display area DA and the bending wires BL may be arranged to overlap a part of the connection wires LL. In detail, the plurality of connection wires LL may be arranged on the bending wires BL and electrically connected to the wires of the display area DA, and may be electrically connected to the bending wires BL in at least three areas. For example, the connection wires LL may contact the bending wires BL in the first non-display area NA1, the bending area BA, and the second non-display area NA2. For example, the connection wires LL may be arranged to overlap the bending wires BL in the first non-display area NA1, the bending area BA, and the second non-display area NA2. Therefore, even though the connection wire LL is damaged by the bending of the display panel 10, signals applied through the connection wires LL may be transmitted to the wires of the display area DA through the bending wire BL.

Accordingly, the possibility of a defect due to the bending of the display panel 10 may be reduced by using the connection wire LL and the bending wire BL dually arranged on the bending area BA. The connection wire LL may be a link wire. The bending wire BL may be a bending wire.

The light source unit 30 may be arranged below a first substrate 110 and emit light toward an upper part (for example, in the Z-axis direction) of the first substrate 110. The light source unit 30 may be a backlight unit.

The display panel 10 may be manufactured based on a flexible plastic material such as polyimide or a flexible glass substrate having a thin thickness. For example, the substrate 100 of the display panel 10 may be made of a transparent glass material in consideration of an etching process. For example, the display panel 10 may be manufactured based on a flexible polymer film. For example, the flexible polymer film may be made of any one of polyethylene terephthalate (PET), polycarbonate (PC), acrylonitrile-butadiene-styrene copolymer (ABS), polymethyl methacrylate (PMMA), polyethylene naphthalate (PEN), polyether sulfone (PES), cyclic olefin copolymer (COC), triacetylcellulose (TAC) film, polyvinyl alcohol (PVA) film, polyimide (PI) film, and polystyrene (PS), which is only an example and is not necessarily limited thereto.

Referring to FIGS. 1 to 4, the display panel 10 according to one example embodiment of the present disclosure may include the substrate 100 including the first substrate 110 and a second substrate 120 spaced apart from each other by the groove G and arranged adjacent to each other, the circuit layer 200 arranged on the substrate 100, the liquid crystal layer 300 arranged on the circuit layer 200, the pad portion PAD arranged on the second substrate 120 for connection with the circuit board 20, the bending wire BL arranged on a planarization layer 240 that extends from the circuit layer 200 to an upper portion of the groove G, and the connection wire LL that connects the pad portion PAD and the bending wire BL. The circuit layer 200 may include a thin film transistor 210, a gate insulating layer 220, a first interlayer dielectric layer 230, the planarization layer 240, a first electrode 250, a second interlayer dielectric layer 260, and a second electrode 270 The thin film transistor 210 may include a gate electrode 211, an active layer 212, a source electrode 213, and a drain electrode 214. In such a case, the planarization layer 240 may extend to a part of the second non-display area NA2 through the bending area BA to be arranged on the upper portion of the groove G. Therefore, when the substrate 100 is etched in order to form the groove G, the planarization layer 240 may serve as an anti-etching layer. The first substrate 110 may be a first area of the substrate 100, and the second substrate 120 may be a second area of the substrate 100. The first area of the substrate 100 and the second area of the substrate 100 may be spaced apart from each other by the groove G and arranged adjacent to each other.

In addition, the display panel 10 according to one example embodiment of the present disclosure may further include a pattern layer 400 arranged on the bending wire BL.

In addition, the display panel 10 according to one example embodiment of the present disclosure may further include a color filter layer 500 and a black matrix 600 arranged on the liquid crystal layer 300, a sealant 310 surrounding the liquid crystal layer 300, and at least one column 320 arranged between the color filter layer 500 and the circuit layer 200. For example, the color filter layer 500 and a black matrix 600 arranged adjacent to each other on the liquid crystal layer 300, without being limited thereto.

In addition, the display panel 10 according to one example embodiment of the present disclosure may further include a cover member 700 arranged on the color filter layer 500 and the black matrix 600. For example, the cover member 700 may be arranged to cover and overlap the color filter layer 500 and the black matrix 600. Therefore, the cover member 700 may protect the color filter layer 500 and the black matrix 600.

In addition, the display panel 10 according to one example embodiment of the present disclosure may further include a lower polarization layer DPOL arranged below the first substrate 110 and an upper polarization layer UPOL arranged above the cover member 700. In such a case, the lower polarization layer DPOL and the upper polarization layer UPOL may overlap the color filter layer 500, without being limited thereto. For example, the lower polarization layer DPOL and the upper polarization layer UPOL may be configured to correspond with the color filter layer 500.

The substrate 100 may be made of glass, metal, plastic, etc., but is not limited thereto. However, the substrate 100 may use a glass substrate having a predetermined strength for an etching process for process simplification.

A manufacturing process of the display panel according to one example embodiment of the present disclosure is described below with reference to FIGS. 5A to 5D.

Referring to FIGS. 5A and 5B, in order to form the plurality of display panels 10, components of the display panel 10, for example, the circuit layer 200, the liquid crystal layer 300, the pad portion PAD, the bending wire BL, the connection wire LL, etc., may be arranged on one mother substrate MS. The mother substrate MS may be made of glass. In such a case, a plurality of semi-finished panels UP separated through a cutting process may be formed using the one mother substrate MS. The semi-finished panel UP may represent a panel before the display panel 10 is separated, and may be implemented in a form in which the components of the display panel 10 are arranged on the mother substrate MS. In addition, a plurality of grooves G may be formed on the lower surface side of the mother substrate MS in correspondence to the grooves G of the display panel 10 through an etching process. Therefore, process optimization may be implemented by forming the plurality of grooves G on the lower surface side of the mother substrate MS through a one-time etching process. In such a case, since the substrate 100 made of glass is processed through the etching process, a decrease in the rigidity of the glass substrate may be minimized. Therefore, the rigidity of the glass substrate may be maintained.

Referring to FIG. 5A, the circuit layer 200, the liquid crystal layer 300, the pad portion PAD, the bending wire BL, the connection wire LL, etc., may be arranged on the upper surface of the one mother substrate MS. Therefore, the plurality of semi-finished panels UP may be formed using the one mother substrate MS.

Referring to FIGS. 5B and 5C, the plurality of grooves G may be formed on the mother substrate MS by etching a part of the lower surface of the mother substrate MS by using a patterned mask Mask and an etching solution. The groove G may be formed in a tapered shape, but is not necessarily limited thereto. Since the plurality of grooves G are formed on the mother substrate MS through the one-time etching process, the manufacturing process of the display panel 10 may be simplified. As the etching solution, phosphoric acid (HNO₃), hydrofluoric acid (HF), etc., may be used.

For example, the plurality of grooves G may be formed on the lower surface side of the mother substrate MS in correspondence to the grooves G of the display panel 10 by etching a part of the lower surface of the mother substrate MS by using a patterned mask Mask and an etching solution, without being limited thereto.

The gate insulating layer 220 and the first interlayer dielectric layer 230 of the circuit layer 200 arranged on the mother substrate MS may be etched by the etching solution. Therefore, a part of the lower surface of the planarization layer 240 may be exposed by the groove G. For example, a portion of the gate insulating layer 220 and a portion of the first interlayer dielectric layer 230 of the circuit layer 200 arranged on the mother substrate MS may be etched by the etching solution and the part of the lower surface of the planarization layer 240 may be exposed by the etched gate insulating layer 220 and first interlayer dielectric layer 230. Since the planarization layer 240 may be made of an organic insulating material having strong corrosion resistance to the etching solution, the planarization layer 240 acts as an etch stop, halting the etching process when the etching solution reaches the planarization layer 240.

The groove G may be formed up to the planarization layer 240 by the etching process, and the gate insulating layer 220 and the first interlayer dielectric layer 230 of the circuit layer 200 arranged on the mother substrate MS may be removed by the groove G together with the mother substrate MS. For example, the gate insulating layer 220 and the first interlayer dielectric layer 230 of the circuit layer 200 may be disposed in the first non-display area NA1 and the second non-display area NA2. The groove G may be arranged to correspond to the bending area BA of the display panel 10. Since the gate insulating layer 220 and the first interlayer dielectric layer 230 are not arranged on the groove G, damage such as cracks due to stress caused by bending does not occur in the gate insulating layer 220 and the first interlayer dielectric layer 230. For example, even though the gate insulating layer 220 and the first interlayer dielectric layer 230 are made of an inorganic insulating material vulnerable to bending, since the gate insulating layer 220 and the first interlayer dielectric layer 230 are not arranged in the bending area BA, the gate insulating layer 220 and the first interlayer dielectric layer 230 are not damaged by stress caused by bending. In addition, since the second interlayer dielectric layer 260 made of an inorganic insulating material is also not arranged in the bending area BA, the second interlayer dielectric layer 260 is not damaged by stress caused by bending.

Referring to FIG. 5D, by performing a cutting process along a cutting line CL, the plurality of display panels 10 may be separated, respectively.

The groove G may be formed in the substrate 100 by the etching process, and the substrate 100 may be divided into the first substrate 110 and the second substrate 120 by the groove G. For example, the groove G may be disposed between the first substrate 110 and the second substrate 120.

The first substrate 110 may include the display area DA and the first non-display area NA1, and may be made of a transparent glass material.

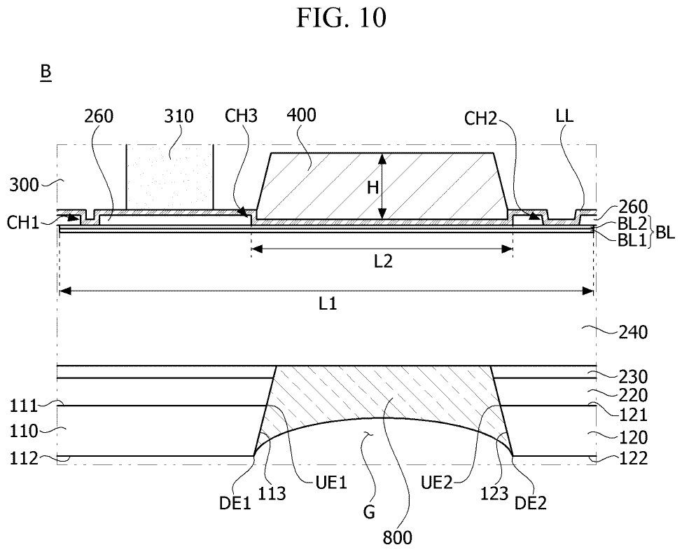

Referring to FIG. 10, the first substrate 110 may include a first upper surface 111 that contacts the circuit layer 200, a first lower surface 112 that is an opposite surface of the first upper surface 111, and a first side surface 113 that connects the first upper surface 111 and the first lower surface 112. The first substrate 110 may include a first upper edge UE1 where the first upper surface 111 and the first side surface 113 meet each other, and a first lower edge DE1 where the first lower surface 112 and the first side surface 113 meet each other. The first side surface 113 may be an inclined surface having a predetermined slope with respect to the first lower surface 112. Since the first side surface 113 is formed by the etching process, a curved surface may be formed at the first lower edge DE1 where the first lower surface 112 and the first side surface 113 meet each other.

The second substrate 120 may be arranged in the second non-display area NA2 and may be made of a transparent glass material.

The second substrate 120 may include a second upper surface 121 that contacts the gate insulating layer 220, a second lower surface 122 that is an opposite surface of the second upper surface 121, and a second side surface 123 that connects the second upper surface 121 and the second lower surface 122. The second substrate 120 may include a second upper edge UE2 where the second upper surface 121 and the second side surface 123 meet each other, and a second lower edge DE2 where the second lower surface 122 and the second side surface 123 meet each other. The second side surface 123 may be an inclined surface having a predetermined slope with respect to the second lower surface 122. Since the second side surface 123 is formed by the etching process, a curved surface may be formed at the second lower edge DE2 where the second lower surface 122 and the second side surface 123 meet each other.

The circuit layer 200 may be arranged in the display area DA, and some components of the circuit layer 200 may be arranged in one or more of the first non-display area NA1, the bending area BA, and the second non-display area NA2. For example, the circuit layer 200 may be arranged on the first upper surface 111 of the first substrate 110, and some components of the circuit layer 200 may extend to the second non-display area NA2 through the first non-display area NA1 and the bending area BA. For example, the gate insulating layer 220 and the first interlayer dielectric layer 230 of the circuit layer 200 may be arranged in the first non-display area NA1 and the second non-display area NA2. For example, the gate insulating layer 220 and the first interlayer dielectric layer 230 of the circuit layer 200 may be removed from the bending area BA, without being limited thereto. In addition, the planarization layer 240 of the circuit layer 200 may be arranged in a part of the first non-display area NA1, the bending area BA, and the second non-display area NA2. In addition, the second interlayer dielectric layer 260 may be arranged in the first non-display area NA1 and the second non-display area NA2. For example, the second interlayer dielectric layer 260 may be removed from the bending area BA, without being limited thereto.

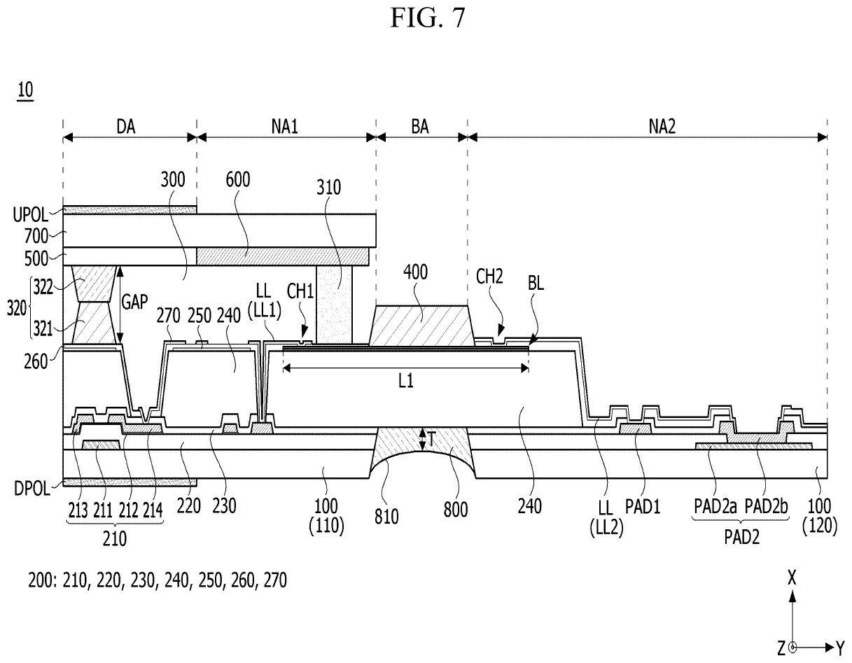

Referring to FIG. 7, the circuit layer 200 may include the thin film transistor 210, the gate insulating layer 220 covering the gate electrode 211 of the thin film transistor 210, the first interlayer dielectric layer 230 covering the active layer 212, the source electrode 213, and the drain electrode 214 of the thin film transistor 210, the planarization layer 240 arranged on the first interlayer dielectric layer 230, the first electrode 250 arranged on the planarization layer 240, the second interlayer dielectric layer 260 arranged on the first electrode 250, and the second electrode 270 arranged on the second interlayer dielectric layer 260, without being limited thereto. More or less layers may be included.

The thin film transistor 210 may include the gate electrode 211, the active layer 212, the source electrode 213, and the drain electrode 214.

The gate electrode 211 may be arranged on the first upper surface 111 of the first substrate 110.

The gate electrode 211 may be made of a conductive material. For example, the gate electrode 211 may be made of a metal material. For example, the gate electrode 211 may be a single layer or a multilayer made of one of molybdenum (Mo), aluminum (Al), chromium (Cr), gold (Au), titanium (Ti), nickel (Ni), neodymium (Nd), and copper (Cu), or an alloy thereof, but is not limited thereto.

A first pad layer PAD2a of the second pad portion PAD2 may be arranged on the second upper surface 121 of the second substrate 120.

The first pad layer PAD2a may be made of a conductive material. For example, the first pad layer PAD2a may be made of a metal material. For example, the gate electrode 211 may be a single layer or a multilayer made of one of molybdenum (Mo), aluminum (Al), chromium (Cr), gold (Au), titanium (Ti), nickel (Ni), neodymium (Nd), and copper (Cu), or an alloy thereof, but is not limited thereto.

In addition, the first pad layer PAD2a may be formed together with the gate electrode 211 by the same mask process of forming the gate electrode 211. For example, the first pad layer PAD2a on the second upper surface 121 of the second substrate 120 may be formed together with the gate electrode 211 on the first upper surface 111 of the first substrate 110 by the same mask process of forming the gate electrode 211, but is not limited thereto.

The gate insulating layer 220 may be arranged on the substrate 100, and arranged in the display area DA, the first non-display area NA1, and the second non-display area NA2 by being etched by the etching process. For example, the gate insulating layer 220 may be arranged on the first substrate 110 to cover the gate electrode 211. The gate insulating layer 220 may also be arranged on the second substrate 120 to cover the first pad layer PAD2a of the second pad portion PAD2.

Since the gate insulating layer 220 may be made of an inorganic insulating material, the gate insulating layer 220 may be etched by the etching process. Therefore, the gate insulating layer 220 may be separated into a gate insulating layer 220 arranged on the first substrate 110 and a gate insulating layer 220 arranged on the second substrate 120.

The gate insulating layer 220 may be made of an inorganic insulating material such as silicon oxide (SiOₓ) and silicon nitride (SiNₓ). The gate insulating layer 220 may be a single layer or a multilayer made of an inorganic insulating material, but is not limited thereto.

The active layer 212 may be arranged on the gate insulating layer 220 arranged on the first substrate 110. For example, the active layer 212 may be disposed to cover a portion of the gate insulating layer 220 arranged on the first substrate 110. The active layer 212 may overlap the first substrate 110. In addition, the active layer 212 may overlap the gate electrode 211 in the Z-axis direction.

The active layer 212 may be made of amorphous silicon (a-Si), polycrystalline silicon (poly-Si), an oxide semiconductor, an organic semiconductor, etc., but is not necessarily limited thereto.

The first pad portion PAD1 may be arranged on the gate insulating layer 220 arranged on the second substrate 120. For example, the first pad portion PAD1 may overlap the second substrate 120. In addition, the gate insulating layer 220 may be arranged between the second substrate 120 and the first pad portion PAD1.

The first pad portion PAD1 may be made of a conductive material. For example, the first pad portion PAD1 may be made of a metal material. For example, the first pad portion PAD1 may include a metal such as aluminum (Al), chromium (Cr), copper (Cu), molybdenum (Mo), titanium (Ti), and tungsten (W).

The first pad portion PAD1 may be electrically connected to a chip (not shown) arranged on the first pad portion PAD1. For example, the first pad portion PAD1 may be electrically connected to the chip (not shown) via the connection wire LL arranged on the first pad portion PAD1. The first pad portion PAD1 is connected to the chip (not shown) via the connection wire LL as an example, but is not necessarily limited thereto. For example, the first pad portion PAD1 may also be directly connected to the chip (not shown) without the connection wire LL. The chip may include a driving circuit. The connection wire LL arranged on the first pad portion PAD1 may be a second connection wire LL2.

For example, the source electrode 213 and the drain electrode 214 of the thin film transistor 210 may be disposed on the active layer 212.

In addition, the first pad portion PAD1 may be formed together with the source electrode 213 and the drain electrode 214 by the same mask process of forming the source electrode 213 and the drain electrode 214, but is not limited thereto.

The second pad layer PAD2b of the second pad portion PAD2 may be arranged on the gate insulating layer 220 arranged on the second substrate 120. For example, a part of the second pad layer PAD2b may be arranged on the gate insulating layer 220. In addition, the second pad layer PAD2b may be electrically connected to the first pad layer PAD2a by using a contact hole formed in the gate insulating layer 220. Therefore, the second pad layer PAD2b of the second pad portion PAD2 may be arranged on the first pad layer PAD2a and electrically connected to the first pad layer PAD2a. For example, the second pad layer PAD2b of the second pad portion PAD2 may be arranged on the gate insulating layer 220 and a portion of the first pad layer PAD2a exposed by the contact hole formed in the gate insulating layer 220.

The second pad layer PAD2b may be made of a conductive material. For example, the second pad layer PAD2b may be made of a metal material. For example, the second pad layer PAD2b may include a metal such as aluminum (Al), chromium (Cr), copper (Cu), molybdenum (Mo), titanium (Ti), and tungsten (W).

In addition, the second pad layer PAD2b may be formed together with the source electrode 213 and the drain electrode 214 by the same mask process of forming the source electrode 213 and the drain electrode 214, but is not limited thereto.

In addition, the second pad layer PAD2b may be electrically connected to the circuit board 20. For example, the second pad layer PAD2b may be connected to the circuit board 20 via the connection wire LL arranged on the second pad layer PAD2b. The connection wire LL arranged on the second pad layer PAD2b may be the second connection wire LL2.

The source electrode 213 may be arranged on the active layer 212. For example, the source electrode 213 may be located in a different layer from the gate electrode 211. The source electrode 213 may be insulated from the gate electrode 211 by the gate insulating layer 220.

The source electrode 213 may be electrically connected to a source region of the active layer 212, and the source electrode 213 may include an area overlapping the source region of the active layer 212. For example, the source electrode 213 may directly contact the source region of the active layer 212.

The source electrode 213 may include a conductive material. For example, the source electrode 213 may include a metal such as aluminum (Al), chromium (Cr), copper (Cu), molybdenum (Mo), titanium (Ti), and tungsten (W).

The drain electrode 214 may be arranged on the active layer 212. For example, the drain electrode 214 may be located in a different layer from the gate electrode 211. The drain electrode 214 may be insulated from the gate electrode 211 by the gate insulating layer 220. The drain electrode 214 may be arranged in the same layer as the source electrode 213. The drain electrode 214 may be arranged spaced apart from the source electrode 213.

The drain electrode 214 may be electrically connected to a drain region of the active layer 212, and the drain electrode 214 may include an area overlapping the drain region of the active layer 212. For example, the drain electrode 214 may directly contact the drain region of the active layer 212.

The drain electrode 214 may include a conductive material. For example, the drain electrode 214 may include a metal such as aluminum (Al), chromium (Cr), copper (Cu), molybdenum (Mo), titanium (Ti), and tungsten (W).

The first interlayer dielectric layer 230 arranged on the substrate 100 may be arranged on the display area DA, the first non-display area NA1, and the second non-display area NA2 because being etched first by an etching process. For example, the first interlayer dielectric layer 230 may be arranged on the first substrate 110 to cover the gate electrode 211, etc. In addition, the first interlayer dielectric layer 230 may be arranged on the second substrate 120 to cover the first pad portion PAD1 and the second pad layer PAD2b of the second pad portion PAD2. For example, the first interlayer dielectric layer 230 may be arranged on source electrode 213 and the drain electrode 214.

For example, the first interlayer dielectric layer 230 may be arranged on the first substrate 110 to cover the active layer 212, the source electrode 213 and the drain electrode 214. The first interlayer dielectric layer 230 may also be arranged on the second substrate 120 to cover the first pad portion PAD1 and the second pad layer PAD2b of the second pad portion PAD2.

The first interlayer dielectric layer 230 may be arranged on the active layer 212, the source electrode 213, and the drain electrode 214. In such a case, the first interlayer dielectric layer 230 may cover the active layer 212, the source electrode 213, and the drain electrode 214 on the first substrate 110. Therefore, the first interlayer dielectric layer 230 may protect the active layer 212, the source electrode 213, and the drain electrode 214.

In addition, the first interlayer dielectric layer 230 may be arranged on the first pad portion PAD1 and the second pad layer PAD2b of the second pad portion PAD2. In such a case, the first interlayer dielectric layer 230 may cover a part of the first pad portion PAD1 and the second pad layer PAD2b on the second substrate 120. Therefore, the first interlayer dielectric layer 230 may protect a part of the first pad portion PAD1 and the second pad layer PAD2b.

The first interlayer dielectric layer 230 may be made of an inorganic insulating material such as silicon oxide (SiOₓ) and silicon nitride (SiNₓ). The first interlayer dielectric layer 230 may be a single layer or a multilayer made of an inorganic insulating material, but is not limited thereto.

The planarization layer 240 may be arranged on the first interlayer dielectric layer 230. In such a case, the planarization layer 240 of the circuit layer 200 may extend to a part of the non-display area NA2 through the bending area BA to be arranged on the upper portion of the groove G. Therefore, the planarization layer 240 may overlap the second substrate 120 in the second non-display area NA2. For example, the planarization layer 240 may overlap the first substrate 110 in the first non-display area NA1.

When the substrate 100 is etched in order to form the groove G, the planarization layer 240 is made of an organic insulating material and serves as an anti-etching layer, so that the bending wire BL arranged on the planarization layer 240 may be protected from an etching solution.

The planarization layer 240 may be arranged on the groove G. For example, since the planarization layer 240 may extend to a part of the second non-display area NA2 through the first non-display area NA1 and the bending area BA, the planarization layer 240 may cover the upper portion of the groove G. Therefore, the display device according to one example embodiment of the present disclosure does not need to arrange a separate anti-etching layer covering the upper portion of the groove G, so that productivity in the process may be improved.

The planarization layer 240 may be made of a transparent organic insulating material. For example, the planarization layer 240 may be made of one or more materials among polyacrylates resin, epoxy resin, phenolic resin, polyamides resin, polyimides resin, unsaturated polyesters resin, polyphenylenethers resin, polyphenylene sulfides resin, and benzocyclobutene, but is not limited thereto. The planarization layer 240 may be a single layer or a multilayer made of an organic insulating material.

In addition, since the planarization layer 240 is made of an organic insulating material having relatively excellent ductility compared to an inorganic insulating material, it may easily cope with bending of the display panel 10. For example, since the planarization layer 240 may be arranged in the bending area BA and is made of an organic insulating material with good ductility, the planarization layer 240 may be easily bent without damage such as cracks.

The first electrode 250 may be arranged on the planarization layer 240. The first electrode 250 may be a common electrode.

The first electrode 250 may be made of a transparent conductive material or an opaque conductive material. For example, the first electrode 250 may be made of indium tin oxide (ITO), indium zinc oxide (IZO), or other conductive materials.

A voltage may be applied to the first electrode 250 and the second electrode 270. Therefore, the liquid crystal layer 300 may be driven to display an image. In such a case, a voltage may be applied to the second electrode 270 through the drain electrode 214.

The bending wire BL may be arranged on the planarization layer 240. In such a case, the bending wire BL may be arranged in the first non-display area NA1, the bending area BA, and the second non-display area NA2. As one example, the bending wire BL may be arranged in a part of the first non-display area NA1, the bending area BA, and the second non-display area NA2. For example, the bending wire BL may be arranged on the planarization layer 240 arranged in the first non-display area NA1, the bending area BA, and the second non-display area NA2.

The bending wire BL may be formed to have a predetermined first length L1 in the Y-axis direction. The bending wire BL may overlap the groove G in the Z-axis direction, and the first length L1 of the bending wire BL in the Y-axis direction may be greater than a width W1 of the groove G. The first length L1 of the bending wire BL in the Y-axis direction may be greater than a width W2 of the pattern layer 400. The width W1 of the groove G may be a first width, and the width W2 of the pattern layer 400 may be a second width.

The bending wire BL may be made of a conductive material. For example, the bending wire BL may be made of a metal material. For example, the bending wire BL may be a single layer or a multilayer made of one of indium tin oxide (ITO), indium zinc oxide (IZO), molybdenum (Mo), aluminum (Al), chromium (Cr), gold (Au), titanium (Ti), nickel (Ni), neodymium (Nd), and copper (Cu), or an alloy thereof, but is not limited thereto. For example, the bending wire BL may be formed in a double layer structure.

The bending wire BL includes at least two layers including different materials. For example, the bending wire BL may include a first layer BL1 and a second layer BL2. Materials of the first layer BL1 and the second layer BL2 may be different from each other. Therefore, the bending wire BL may easily cope with stress caused by bending. For example, the bending wire BL may be arranged on the planarization layer 240.

In the bending wire BL, at least one of the first layer BL1 and the second layer BL2 may include the same metal layer as the first electrode 250, but is not limited thereto.

In addition, the first layer BL1 and the second layer BL2 of the bending wire BL may be made of different materials from the first electrode 250.

The first layer BL1 may be arranged on the planarization layer 240. The first layer BL1 may be made of transparent indium tin oxide (ITO) or indium zinc oxide (IZO). For example, the first layer BL1 may include the same material as the first electrode 250 and may be formed together with the first electrode 250 through the same mask process for forming the first electrode 250, but is not limited thereto.

The second layer BL2 may be arranged on the first layer BL1. The second layer BL2 may have the same length as the first layer BL1 based on the Y-axis direction. For example, the first layer BL1 and the second layer BL2 may be formed to have the predetermined first length L1 in the Y-axis direction.

The second layer BL2 may be made of a different material from the first layer BL1. For example, the second layer BL2 may be made of one of molybdenum (Mo), aluminum (Al), chromium (Cr), gold (Au), titanium (Ti), nickel (Ni), neodymium (Nd), and copper (Cu), or an alloy thereof. For example, the second layer BL2 may include copper (Cu).

In addition, the bending wire BL may include a different material from the material of the connection wire LL. For example, since the connection wire LL may be made of indium tin oxide (ITO) or indium zinc oxide (IZO) and the second layer BL2 of the bending wire BL may be made of copper, the bending wire BL may include a different material from the material of the connection wire LL.

Accordingly, the display device according to one example embodiment of the present disclosure may easily cope with stress caused by bending because the first connection wire LL1 and the second connection wire LL2 are connected via the bending wire BL. Moreover, since the bending wire BL includes at least two layers including different materials, it may more effectively cope with stress caused by bending.

The second interlayer dielectric layer 260 may be arranged on the first electrode 250 and the bending wire BL. For example, the second interlayer dielectric layer 260 may be arranged on the planarization layer 240 to cover the first electrode 250 and the bending wire BL. In such a case, the second interlayer dielectric layer 260 may be arranged in the display area DA, the first non-display area NA1, and the second non-display area NA2. For example, the second interlayer dielectric layer 260 may be arranged in the bending area BA. The second interlayer dielectric layer 260 may be arranged between the bending wire BL and the first connection wire LL1 in the first non-display area NA1 based on the Z-axis direction.

In the second non-display area NA2, the second interlayer dielectric layer 260 may be arranged between the bending wire BL and the second connection wire LL2.

The second interlayer dielectric layer 260 may be made of an inorganic insulating material such as silicon oxide (SiOx) and silicon nitride (SiNx). The second interlayer dielectric layer 260 may be a single layer or a multilayer made of an inorganic insulating material, but is not limited thereto.

The second electrode 270 may be arranged on the second interlayer dielectric layer 260. The second electrode 270 may be electrically connected to the drain electrode 214 through a contact hole formed in the planarization layer 240 and the second interlayer dielectric layer 260. The second electrode 270 may be a pixel electrode. For example, the second electrode 270 may be arranged on the second interlayer dielectric layer 260 in the display area DA.

The second electrode 270 may be made of a transparent conductive material or an opaque conductive material. For example, the second electrode 270 may be made of indium tin oxide (ITO), indium zinc oxide (IZO), or other conductive materials.

The connection wire LL may be arranged on the second interlayer dielectric layer 260. For example, the plurality of connection wires LL may be arranged on the second interlayer dielectric layer 260 to transmit signals applied from the circuit board 20 to the wires of the display area DA. In such a case, the plurality of connection wires LL may be connected to the first pad portion PAD1 and the second pad portion PAD2 through contact holes formed in the first interlayer dielectric layer 230, the planarization layer 240, and the second interlayer dielectric layer 260, or the first and second interlayer dielectric layers 230 and 260. For example, the connection wire LL may be arranged on the second interlayer dielectric layer 260 in the first non-display area NA1 and the second non-display area NA2.

The connection wire LL may be made of a transparent conductive material or an opaque conductive material. For example, the second electrode 270 may be made of indium tin oxide (ITO), indium zinc oxide (IZO), or other conductive materials.

The connection wires LL may be formed together with the second electrode 270 by the same mask process of forming the second electrode 270, but is not limited thereto.

The connection wires LL may include the first connection wire LL1 and the second connection wire LL2 arranged spaced apart from each other. The first connection wire LL1 and the second connection wire LL2 may be electrically connected via the bending wire BL. For example, the pattern layer 400 may be arranged between the first connection wire LL1 and the second connection wire LL2 based on the Y-axis direction. For example, the pattern layer 400 may be arranged on the bending wire BL between the first connection wire LL1 and the second connection wire LL2. For example, the connection wires LL including the first connection wire LL1 and the second connection wire LL2 may be not disposed in the bending area BA. In such a case, the bending wire BL arranged below the pattern layer 400 may be electrically connected to the first connection wire LL1 through a first contact hole CH1 and may be electrically connected to the second connection wire LL2 through a second contact hole CH2. Therefore, the first connection wire LL1 may contact one side of the bending wire BL, and the second connection wire LL2 may contact the other side of the bending wire BL. The first contact hole CH1 may be arranged in the first non-display area NA1. The first contact hole CH1 may be formed to penetrate the second interlayer dielectric layer 260 arranged between the bending wire BL and the first connection wire LL1. The second contact hole CH2 may be arranged in the second non-display area NA2. The second contact hole CH2 may be formed to penetrate the second interlayer dielectric layer 260 arranged between the bending wire BL and the second connection wire LL2.

The first connection wire LL1 may be arranged in the first non-display area NA1. For example, the first connection wire LL1 may be arranged on the second interlayer dielectric layer 260 of the first non-display area NA1. In addition, the first connection wire LL1 may be electrically connected to the bending wire BL through the first contact hole CH1 in the first non-display area NA1.

The second connection wire LL2 may be arranged in the second non-display area NA2. For example, the second connection wire LL2 may be arranged on the second interlayer dielectric layer 260 of the second non-display area NA2. The second connection wire LL2 may be electrically connected to the bending wire BL through the second contact hole CH2 in the second non-display area NA2.

In such a case, the bending wire BL arranged below the pattern layer 400 may be electrically connected to the first connection wire LL1 in the first non-display area NA1 through a first contact hole CH1 and may be electrically connected to the second connection wire LL2 in the second non-display area NA2 through a second contact hole CH2.

The liquid crystal layer 300 may be arranged on the second interlayer dielectric layer 260, the second electrode 270, and the first connection wire LL1, and may include an alignment film (not shown) for easily inducing the arrangement of liquid crystals. For example, the liquid crystal layer 300 may be arranged on the second interlayer dielectric layer 260, the second electrode 270, and the first connection wire LL1 in the display area DA and the first non-display area NA1, without being limited thereto.

The sealant 310 may surround the liquid crystal layer 300. For example, the sealant 310 may be arranged along the perimeter of the liquid crystal layer 300.

Referring to FIG. 3, the sealant 310 may be arranged on the second interlayer dielectric layer 260. For example, the sealant 310 may be arranged between the second interlayer dielectric layer 260 and the black matrix 600 based on the Z-axis direction. In addition, the sealant 310 may contact the second interlayer dielectric layer 260, but is not necessarily limited thereto. For example, the sealant 310 may also contact the connection wire LL arranged on the second interlayer dielectric layer 260. In such a case, the sealant 310 may overlap the bending wire BL in the Z-axis direction.

The sealant 310 may be a photocurable or thermocurable epoxy resin. The sealant 310 may form a gap for injecting liquid crystal between the second interlayer dielectric layer 260 and the black matrix 600. The sealant 310 may play a role in preventing leakage of liquid crystals injected into the gap.

Referring to FIG. 3, at least one column 320 may be arranged on the second interlayer dielectric layer 260. For example, the column 320 may be arranged between the second interlayer dielectric layer 260 and the color filter layer 500 along the Z-axis direction. Therefore, the column 320 may maintain the gap for injecting liquid crystal.

For example, the sealant 310 may be arranged between the second interlayer dielectric layer 260 and the black matrix 600 along the Z-axis direction in the first non-display area NA1. For example, the column 320 may be arranged between the second interlayer dielectric layer 260 and the color filter layer 500 in the display area DA.

The column 320 may include a first column part 321 and a second column part 322, without being limited thereto.

The first column part 321 may be arranged on the second interlayer dielectric layer 260. The first column part 321 may contact the second interlayer dielectric layer 260.

The first column part 321 may be made of an organic insulating material, and may be formed together with the pattern layer 400 by the same mask process of forming the pattern layer 400, but is not limited thereto.

The second column part 322 may be arranged on the first column part 321 and may overlap the first column part 321. The second column part 322 may be disposed between the first column part 321 and the color filter layer 500. The second column part 322 may contact the color filter layer 500.

The second column part 322 may be made of an organic insulating material.

The pattern layer 400 may be arranged on the bending wire BL. Therefore, the pattern layer 400 may protect the bending wires BL from physical and/or chemical impact. For example, the pattern layer 400 may prevent moisture, impurities, etc., from penetrating into the bending wires BL. For example, the pattern layer 400 may be arranged on the bending wire BL in the bending area BA.

The pattern layer 400 may be arranged in the bending area BA, and as the bending area BA is bent, the pattern layer 400 may also be bent. The pattern layer 400 may overlap the groove G.

The pattern layer 400 may be made of an organic insulating material in order to cope with stress caused by bending. For example, the pattern layer 400 may be made of an organic material including a polyester polymer, an acrylic polymer, etc.

Referring to FIGS. 1 to 4, the pattern layer 400 may be provided as a structure having predetermined width W2 and height H, and may be arranged along the X-axis direction. For example, the pattern layer 400 may be formed in a bar shape including a trapezoidal cross-section but is not limited thereto.

The pattern layer 400 may be formed to have the predetermined width W2, and the width W2 of the pattern layer 400 may be the same as the width W1 of the groove G, but is not necessarily limited thereto. For example, the width W2 of the pattern layer 400 may be larger than the width W1 of the groove G. In addition, the width W2 of the pattern layer 400 may be smaller than the first length L1 of the bending wire BL.

The pattern layer 400 may be formed to have the predetermined height H. The height H of the pattern layer 400 may be adjusted. Therefore, the display panel 10 according to one example embodiment of the present disclosure may minimize stress applied to the bending wire BL by adjusting the height H of the pattern layer 400.

FIG. 6 is an example view showing a neutral plane according to bending.

Referring to FIG. 6, the neutral plane may be defined as a plane where a stress state is 0 during bending, and the size of tensile stress or compressive stress is determined in proportion to a distance from the neutral plane. The neutral plane may be located in the center between a plane where the tensile stress is applied and a plane where the compressive stress is applied, based on the Z direction. The plane where the compressive stress is applied may be defined as a plane arranged close to the center of curvature, and the plane where the tensile stress is applied may be defined as an opposite plane of the plane where the compressive stress is applied. For example, the plane where the tensile stress is applied may be defined as a plane arranged away from the center of curvature.

In addition, cracks are more likely to occur in a configuration arranged in an area where the tensile stress is applied than in a configuration arranged in an area where the compressive stress is applied. For example, since the bending wire BL arranged in the bending area BA of the display panel 10 may be arranged in an area where the tensile stress is applied, there is a relatively high probability that cracks will occur in the bending wire BL due to bending of the bending area BA. Therefore, since cracks are more likely to occur in an area subject to the tensile stress than in an area subject to the compressive stress during bending, the stress applied to the bending wire BL may be minimized by moving the neutral plane to be closer to the bending wire BL.

Accordingly, when the pattern layer 400 is arranged on the bending wire BL (see FIG. 3), the display device according to one example embodiment of the present disclosure may position the neutral plane on the bending wire BL or move the neutral plane to be closer to the bending wire BL by adjusting the height H of the pattern layer 400 in a state where the thickness from the pattern layer 400 to the bending wire BL is determined. Therefore, the display panel 10 may reduce stress applied to the bending wire BL during the bending of the display panel 10 by using the pattern layer 400.

The color filter layer 500 may be arranged on the liquid crystal layer 300. In such a case, the color filter layer 500 may be arranged in the display area DA. The black matrix 600 may be arranged in the first non-display area NA1. In addition, the color filter layer 500 may be formed on the same layer as the black matrix 600. For example, the color filter layer 500 and the black matrix 600 may be arranged adjacent to each other.

The color filter layer 500 may include red, green, and blue color filters, but is not limited thereto. For example, the color filter layer 500 may include an acrylic resin and a pigment. The color filter layer 500 may be classified into red, green, and blue depending on the type of pigment that implements a color.

The black matrix 600 may be arranged in the first non-display area NA1, and may be arranged on the liquid crystal layer 300 and the sealant 310.

In addition, the black matrix 600 may have a closed loop shape surrounding the display area DA. Therefore, the black matrix 600 may prevent light leakage. In such a case, the black matrix 600 may overlap the color filter layer 500 in the X-axis direction and the Y-axis direction.

The cover member 700 may be arranged on the color filter layer 500 and the black matrix 600. For example, the cover member 700 may be arranged to cover and overlap the color filter layer 500 and the black matrix 600. Therefore, the cover member 700 may protect the color filter layer 500 and the black matrix 600.

An end of the cover member 700 may protrude further than the black matrix 600 in the Y-axis direction, but is not necessarily limited thereto. For example, the end of the cover member 700 may also be arranged to overlap an end of the black matrix 600 in the Z-axis direction.

The cover member 700 may be made of a transparent plastic material, a glass material, or a reinforced glass material, but is not limited thereto.

The upper polarization layer UPOL may be arranged on the cover member 700. The upper polarization layer UPOL may overlap the color filter layer 500, and may be arranged in the display area DA. For example, the upper polarization layer UPOL may be arranged on a portion of the cover member 700 in the display area DA.

The lower polarization layer DPOL may be arranged below the first substrate 110. For example, the lower polarization layer DPOL may be attached to the lower side of the first substrate 110 through an adhesive member. For example, the lower polarization layer DPOL may overlap the color filter layer 500, and may be arranged in the display area DA.

FIG. 7 is a view showing the coating layer arranged on the display panel according to one example embodiment of the present disclosure.

Referring to FIG. 7, the display panel 10 according to one example embodiment of the present disclosure may further include a coating layer 800 arranged in the groove G.

The coating layer 800 may be arranged below the planarization layer 240 to overlap a part of the bending wire BL. A lower surface 810 of the coating layer 800 may be concavely formed toward the planarization layer 240, but is not necessarily limited thereto. For example, the lower surface 810 of the coating layer 800 may also be substantially flat.

The coating layer 800 may be made of an organic material including a polyester-based polymer or an acrylic-based polymer, but is not limited thereto.

The coating layer 800 may be formed to have a predetermined thickness T in consideration of the position of the neutral plane.

The display device according to one example embodiment of the present disclosure may adjust the thickness T of the coating layer 800 in a state where the thickness from the planarization layer 240 to the bending wire BL or from the planarization layer 240 to the pattern layer 400 is determined. Therefore, the position of the neutral plane may be located on the bending wire BL or moved close to the bending wire BL. Accordingly, the display panel 10 may reduce stress applied to the bending wire BL during the bending of the display panel 10 by using the coating layer 800.

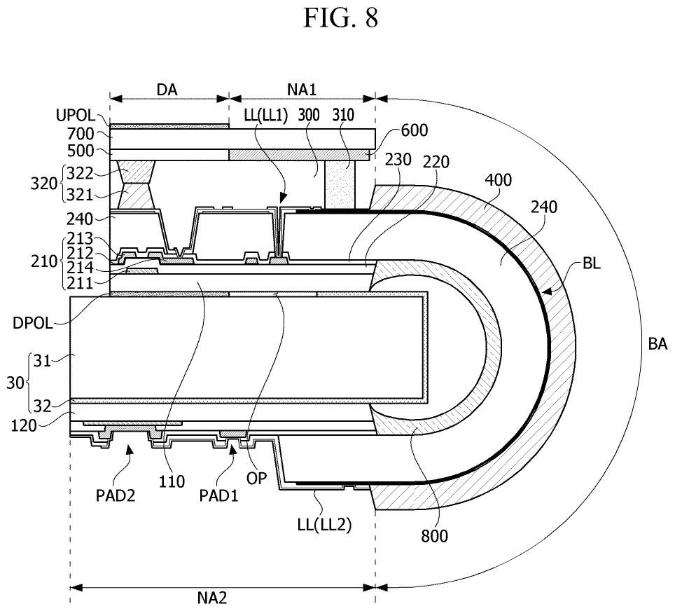

FIG. 8 is a view showing a bent appearance of the display device according to one example embodiment of the present disclosure.

Referring to FIG. 8, the display panel 10 of the display device according to one example embodiment of the present disclosure may be bent. For example, as the bending area BA is bent, the display panel 10 may be bent so that the first substrate 110 and the second substrate 120 face each other. In such a case, the bending area BA may be bent to have a predetermined radius of curvature.

Since the gate insulating layer 220, the first interlayer dielectric layer 230, and the second interlayer dielectric layer 260 made of an inorganic insulating material are not arranged in the bending area BA of the display panel 10 according to one example embodiment of the present disclosure, damage to the gate insulating layer 220, the first interlayer dielectric layer 230, and the second interlayer dielectric layer 260 due to bending may be prevented in advance.

As the bending area BA is bent, the light source unit 30 may be arranged between the first substrate 110 and the second substrate 120. The light source unit 30 may emit light toward the first substrate 110. Therefore, the light source unit 30 may overlap the first substrate 110 in the Z-axis direction. Also, the light source unit 30 may overlap the second substrate 120 in the Z-axis direction.

The light source unit 30 may include a backlight unit 31 and a case 32 that surrounds a light source module.

The backlight unit 31 may emit light toward the first substrate 110. A light source for the backlight unit 31 may use a light emitting diode (LED), but is not necessarily limited thereto.

The case 32 may be arranged to surround the backlight unit 31 to protect the backlight unit 31. In addition, the case 32 may include an opening OP so that light is emitted from the backlight unit 31 toward the first substrate 110. For example, a side of the case 32 facing the first substrate 110 may include an opening OP so that light is emitted from the backlight unit 31 toward the first substrate 110, but is not limited thereto.

The opening OP may be arranged toward the first substrate 110. In addition, the lower polarization layer DPOL may be arranged in the opening OP.

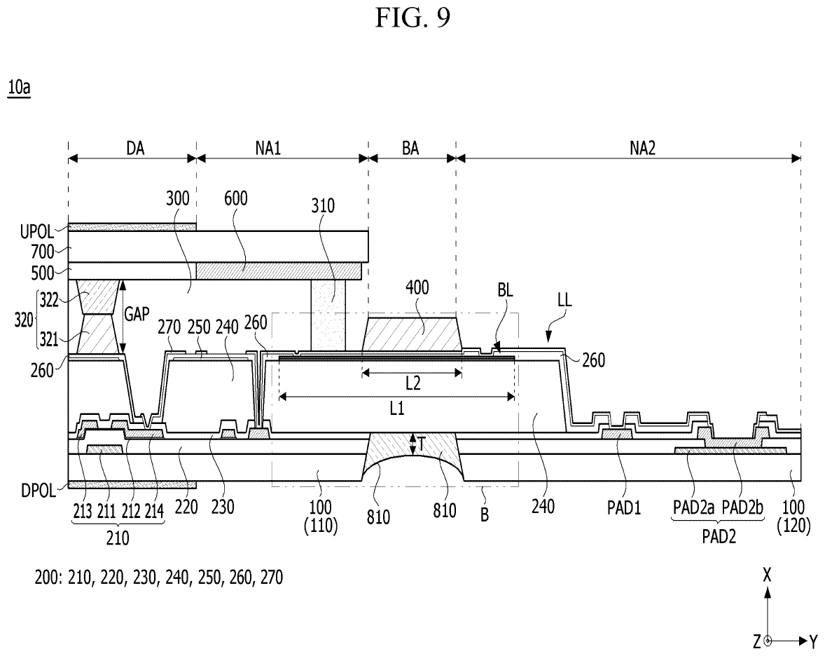

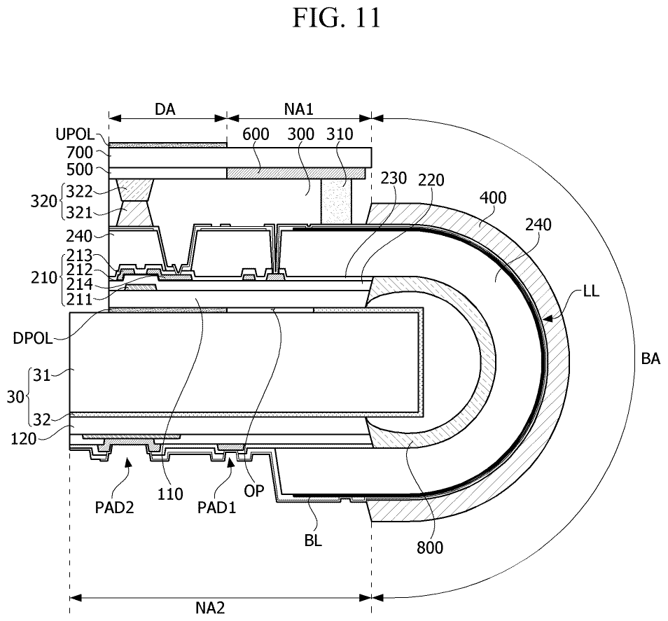

FIG. 9 is a cross-sectional view showing another embodiment of a display panel according to one example embodiment of the present disclosure. FIG. 10 is an example enlarged view showing an area B in FIG. 9. FIG. 11 is a view showing a bent appearance of a display device to which another embodiment of the display panel according to one example embodiment of the present disclosure is utilized. A display panel 10a shown in FIGS. 9 to 11 may be a display panel according to a second embodiment. The display panel 10 shown in FIGS. 3, 7, and 8 may be a display panel according to a first embodiment.

When the display panel 10 according to the first embodiment and the display panel 10a according to the second embodiment are compared with each other with reference to FIGS. 3 and 7 to 11, the display panel 10 according to the first embodiment uses the two first connection wires LL1 and second connection wire LL2 arranged spaced apart from each other with the pattern layer 400 interposed therebetween, but since the display panel 10a according to the second embodiment uses one connection wire LL, the connection wire LL may overlap the bending wire BL in the bending area BA. For example, the connection wire LL of the display panel 10a according to the second embodiment, which extends to the second non-display area NA2 through the first non-display area NA1 and the bending area BA, may be arranged on the bending wire BL in the bending area BA. Therefore, the connection wire LL may contact the bending wire BL in the bending area BA. In such a case, the display panel 10a according to the second embodiment may be applied to the display device according to one example embodiment of the present disclosure instead of the display panel 10 according to the first embodiment.

In describing the display panel 10a according to the second embodiment with reference to FIGS. 3 and 7 to 11, since substantially identical components between the display panel 10 according to the first embodiment (see, e.g., FIGS. 7 and 8 and other figures) and the display panel 10a according to the second embodiment (see, e.g., FIGS. 9 to 11 and other figures) may be denoted by the same reference numerals, detailed descriptions thereof are omitted. The detailed descriptions provided for elements in one or more figures may also apply to elements in other figures that use the same reference numerals.

Referring to FIGS. 9 to 11, the display device according to one example embodiment of the present disclosure may include the display panel 10a including the groove G, the circuit board 20 connected to the pad portion PAD of the display panel 10a, and the light source unit 30 that emits light toward the liquid crystal layer 300 of the display panel 10a.

The display panel 10a according to one example embodiment of the present disclosure may include the substrate 100 including the first substrate 110 and the second substrate 120 spaced apart from each other by the groove G and arranged adjacent to each other, the circuit layer 200 arranged on the substrate 100, the liquid crystal layer 300 arranged on the circuit layer 200, the pad portion PAD arranged on the second substrate 120 for connection with the circuit board 20, the bending wire BL arranged on the planarization layer 240 extending from the circuit layer 200 to the upper portion of the groove G, and the connection wire LL that connects the pad portion PAD and the bending wire BL. The circuit layer 200 may include the thin film transistor 210, the gate insulating layer 220, the first interlayer dielectric layer 230, the planarization layer 240, the first electrode 250, the second interlayer dielectric layer 260, and the second electrode 270. The thin film transistor 210 may include the gate electrode 211, the active layer 212, the source electrode 213, and the drain electrode 214. In such a case, the planarization layer 240 may extend to a part of the second non-display area NA2 through the bending area BA to be arranged on the upper portion of the groove G. Therefore, when the substrate 100 is etched in order to form the groove G, the planarization layer 240 may serve as an anti-etching layer. The first substrate 110 may be a first area of the substrate 100, and the second substrate 120 may be a second area of the substrate 100. The first area of the substrate 100 and the second area of the substrate 100 may be spaced apart from each other by the groove G and arranged adjacent to each other.

In addition, the display panel 10a according to one example embodiment of the present disclosure may further include the pattern layer 400 arranged on the bending wire BL, the color filter layer 500 and the black matrix 600 arranged on the liquid crystal layer 300, the sealant 310 surrounding the liquid crystal layer 300, at least one column 320 arranged between the color filter layer 500 and the circuit layer 200, the cover member 700 arranged on the color filter layer 500 and the black matrix 600, the lower polarization layer DPOL arranged below the first substrate 110, and the upper polarization layer UPOL arranged above the cover member 700. In such a case, the lower polarization layer DPOL and the upper polarization layer UPOL may overlap the color filter layer 500, without being limited thereto. For example, the lower polarization layer DPOL and the upper polarization layer UPOL may be configured to correspond with the color filter layer 500. Further, the cover member 700 may protect the color filter layer 500 and the black matrix 600.

In addition, the display panel 10a according to one example embodiment of the present disclosure may further include the coating layer 800 arranged in the groove G.

The connection wire LL may be arranged in the first non-display area NA1, the bending area BA, and the second non-display area NA2. For example, the connection wire LL may be arranged to extend from the first non-display area NA1 to the second non-display area NA2. For example, the connection wire LL may be arranged to extend from the first non-display area NA1 to the second non-display area NA2 through the bending area BA.

The connection wire LL may be arranged to contact the bending wire BL in the bending area BA. In addition, the pattern layer 400 may be arranged on the connection wire LL. Therefore, the connection wire LL may protect the bending wire BL. For example, the display panel 10a according to one example embodiment of the present disclosure may protect the bending wire BL by arranging a part of the connection wire LL between the bending wire BL and the pattern layer 400. For example, the bending wire BL may include copper (Cu). When copper (Cu) is exposed to air, copper (Cu) may be oxidized. Therefore, when the bending wire BL including copper (Cu) is oxidized, the resistance of the bending wire BL may increase.

Accordingly, the display panel 10a according to one example embodiment of the present disclosure may prevent oxidation of the bending wire BL including copper (Cu) by using the pattern layer 400, and may more effectively prevent oxidation of the bending wire BL by further arranging a part of the connection wire LL between the bending wire BL and the pattern layer 400. Therefore, an increase in the resistance of the bending wire BL due to oxidation may be prevented.

The connection wire LL may contact the bending wire BL in the first non-display area NA1, the bending area BA, and the second non-display area NA2. For example, the connection wire LL may contact the bending wire BL in a portion of the first non-display area NA1, the bending area BA, and a portion of the second non-display area NA2, without being limited thereto. Therefore, the connection wire LL of the display panel 10a according to one example embodiment of the present disclosure may be stably connected to the bending wire BL. For example, even though any one of a part of the connection wire LL or of the bending wires BL arranged in the bending area BA is damaged due to the bending of the display panel 10a, signals applied through the connection wire LL may be transmitted to wires of the display area DA through either the undamaged connection wire LL or bending wire BL. For example, when a part of the connection wire LL is damaged in the bending area BA of the display panel 10a, signals applied through the pad portion PAD may be transmitted to the wires of the display area DA after moving in the order of the connection wire LL of the second non-display area NA2, the second contact hole CH2, the bending wire BL, the first contact hole CH1, and the connection wire LL of the first non-display area NA1.

Referring to FIGS. 9 and 10, the connection wire LL may be arranged on the second interlayer dielectric layer 260. The connection wire LL may be electrically connected to the bending wire BL through the first contact hole CH1, the second contact hole CH2, and a third contact hole CH3.

The first contact hole CH1 may be arranged in the first non-display area NA1, and the connection wire LL may be electrically connected to the bending wire BL through the first contact hole CH1.

The second contact hole CH2 may be arranged in the second non-display area NA2, and the connection wire LL may be electrically connected to the bending wire BL through the second contact hole CH2.

The third contact hole CH3 may be arranged in the bending area BA, and the connection wire LL may be electrically connected to the bending wire BL through the third contact hole CH3. In such a case, a partial area of the connection wire LL that contacts the bending wire BL through the third contact hole CH3 may be formed to have a predetermined second length L2 in the Y-axis direction. The second length L2 may be smaller than the first length L1 of the bending wire BL. For example, when considering the position of the sealant 310 and the contact holes CH1 to CH3 formed in the second interlayer dielectric layer 260, the second length L2 may be smaller than the first length L1 of the bending wire BL.

Accordingly, the display panel 10a according to one example embodiment of the present disclosure is electrically connected to the bending wire BL through the first contact hole CH1, the second contact hole CH2, and the third contact hole CH3, thereby stably transmitting signals applied through the connection wire LL to the wires of the display area DA.

Referring to FIG. 11, the display panel 10a of the display device according to one example embodiment of the present disclosure may be bent. The display panel 10a according to one example embodiment of the present disclosure may have a robust structure against bending because a partial area of the connection wire LL is overlappingly arranged to support the bending wire BL in the bending area BA.

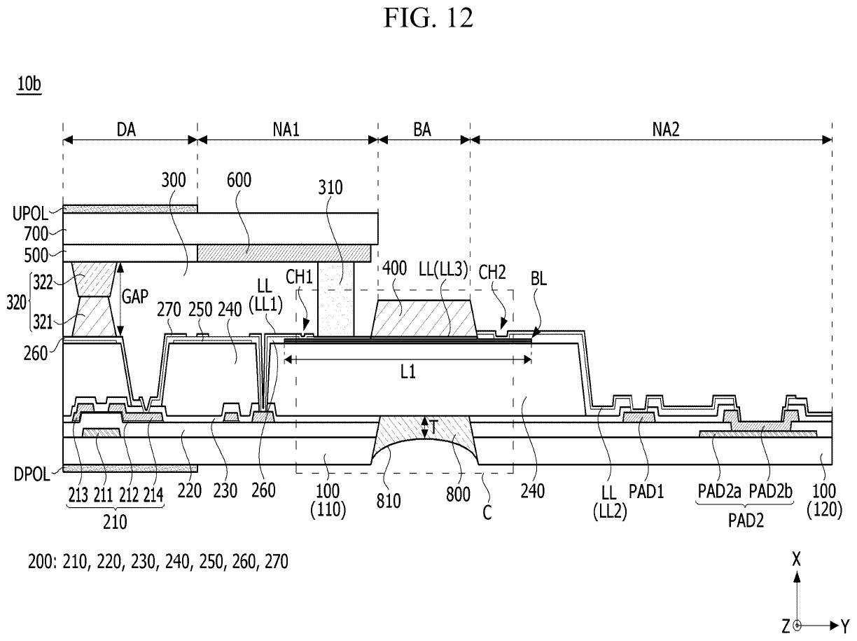

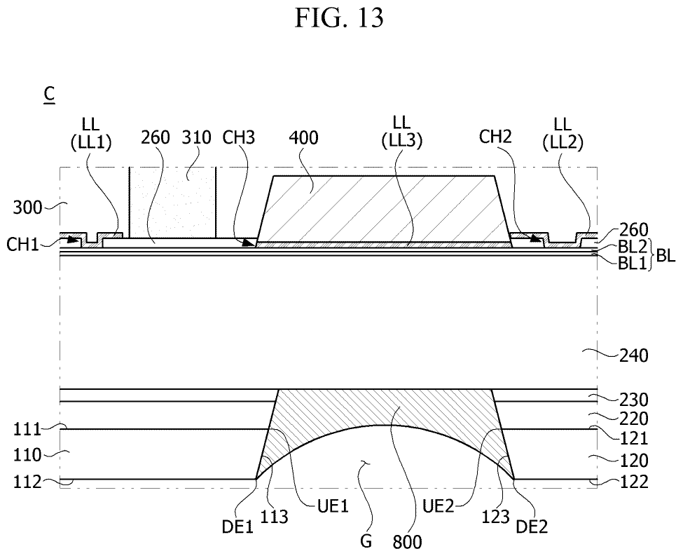

FIG. 12 is a cross-sectional view showing another embodiment of a display panel according to one example embodiment of the present disclosure. FIG. 13 is an example enlarged view showing an area C in FIG. 12. A display panel 10b shown in FIGS. 12 and 13 may be a display panel according to a third embodiment.

When the display panel 10 according to the first embodiment and the display panel 10b according to the third embodiment are compared with each other with reference to FIGS. 3 and 7 to 13, the display panel 10b according to the third embodiment (see, e.g., FIGS. 12 and 13 and other figures) may further include a separate third connection wire LL3 overlapping the bending wire BL. In such a case, the third connection wire LL3 may be arranged on the bending wire BL in the bending area BA. In addition, the display panel 10b according to the third embodiment may be applied to the display device according to one example embodiment of the present disclosure instead of the display panel 10 according to the first embodiment.

In describing the display panel 10b according to the third embodiment with reference to FIGS. 3, 7 to 11, 12, and 13, since substantially identical components between the display panel 10 according to the first embodiment (see, e.g., FIGS. 7 and 8 and other figures) and the display panel 10b according to the third embodiment (see, e.g., FIGS. 12 and 13 and other figures) may be denoted by the same reference numerals, detailed descriptions thereof are omitted. The detailed descriptions provided for elements in one or more figures may also apply to elements in other figures that use the same reference numerals.

Referring to FIGS. 12 and 13, the display device according to one example embodiment of the present disclosure may include the display panel 10b including the groove G, the circuit board 20 connected to the pad portion PAD of the display panel 10b, and the light source unit 30 that emits light toward the liquid crystal layer 300 of the display panel 10b.

The connection wire LL of the display panel 10b may include the first connection wire LL1 located in the first non-display area NA1, the second connection wire LL2 located in the second non-display area NA2, and the third connection wire LL3 located in the bending area BA.

The third connection wire LL3 may be arranged between the first connection wire LL1 and the second connection wire LL2. For example, the first connection wire LL1, the second connection wire LL2 and the third connection wire LL3 may connect to the bending wire BL. The third connection wire LL3 may be spaced apart from each of the first connection wire LL1 and the second connection wire LL2. For example, the first connection wire LL1, the second connection wire LL2, and the third connection wire LL3 may be arranged on the second interlayer dielectric layer 260 while being spaced apart from one another. In such a case, the first connection wire LL1 may be electrically connected to the bending wire BL through the first contact hole CH1. In addition, the second connection wire LL2 may be electrically connected to the bending wire BL through the second contact hole CH2.

The third connection wire LL3 may be arranged to overlap the bending wire BL in the bending area BA. For example, the third connection wire LL3 may be arranged on the bending wire BL in the bending area BA. For example, the third connection wire LL3 may be arranged to contact the bending wire BL in the bending area BA. For example, the third connection wire LL3 may be electrically connected to the bending wire BL through the third contact hole CH3.

Accordingly, the display panel 10b according to one example embodiment of the present disclosure may have a robust structure against bending because the third connection wire LL3 is overlappingly arranged to support the bending wire BL in the bending area BA. In addition, the display panel 10b according to one example embodiment of the present disclosure may prevent oxidation of the bending wire BL including copper (Cu) because the third connection wire LL3 is arranged on the bending wire BL.

Various examples and aspects of the present disclosure are described below. These are provided as examples, and do not limit the scope of the present disclosure.

A display device according to one or more example embodiments of the present disclosure may include a display panel including a groove and a circuit board connected to the display panel, and the display panel may include: a substrate including a first substrate and a second substrate spaced apart from each other by the groove; a circuit layer arranged on the first substrate and including a transistor; an liquid crystal layer arranged on the circuit layer; a planarization layer arranged on the first area and the groove; a pad portion arranged on the second substrate and connected to the circuit board; a bending wire arranged on the planarization layer; and a connection wire connecting the bending wire and the pad portion.

A display device according to one or more example embodiments of the present disclosure may include a display panel that comprises: a groove; a substrate including a first area and a second area spaced apart from each other by the groove; a circuit layer arranged on the first area and including a transistor; a planarization layer arranged on the first area and the groove; a pad portion arranged on the second area; a bending wire arranged on the planarization layer; and a connection wire connected to the bending wire.

According to one or more example embodiments of the present disclosure, the bending wire may include a material different from a material of the connection wire.

According to one or more example embodiments of the present disclosure, the bending wire may include a first layer and a second layer, and a material of the first layer and a material of a second layer may be different from each other.

According to one or more example embodiments of the present disclosure, the planarization layer arranged on the groove may extend to overlap the second area.

According to one or more example embodiments of the present disclosure, the display panel may further include a pattern layer arranged on the bending wire, and the pattern layer may be made of an organic insulating material.

According to one or more example embodiments of the present disclosure, a width of the pattern layer may be smaller than a length of the bending wire based on a Y-axis direction.

According to one or more example embodiments of the present disclosure, the pattern layer may overlap the groove in a Z-axis direction.

According to one or more example embodiments of the present disclosure, the display panel may further include a coating layer arranged in the groove.

According to one or more example embodiments of the present disclosure, the display panel may further include a color filter layer and a black matrix arranged on the liquid crystal layer, and a sealant surrounding the liquid crystal layer.

According to one or more example embodiments of the present disclosure, the sealant may overlap the bending wire in the Z-axis direction.

According to one or more example embodiments of the present disclosure, the display panel may further include a cover member arranged on the color filter layer and the black matrix.

According to one or more example embodiments of the present disclosure, the display panel may further include a light source unit that overlaps the first substrate.

According to one or more example embodiments of the present disclosure, the connection wire may include a first connection wire that contacts one side of the bending wire and a second connection wire that contacts the other side of the bending wire.

According to one or more example embodiments of the present disclosure, the display panel may further include a pattern layer arranged between the first connection wire and the second connection wire, the first connection wire and the second connection wire may be connected via the bending wire.

According to one or more example embodiments of the present disclosure, the display panel may further include a second interlayer dielectric layer arranged between the bending wire and the first connection wire and between the bending wire and the second connection wire, the first connection wire may contact the bending wire through a first contact hole of the second interlayer dielectric layer, and the second connection wire may contact the bending wire through a second contact hole of the second interlayer dielectric layer.

According to one or more example embodiments of the present disclosure, at least a portion of the connection wire may be arranged on the bending wire.

According to one or more example embodiments of the present disclosure, the display panel may further include a pattern layer arranged on the connection wire, and the pattern layer may overlap the groove in the Z-axis direction.

According to one or more example embodiments of the present disclosure, the display panel may further include a second interlayer dielectric layer arranged between the bending wire and the connection wire, the connection wire may contact the bending wire through a first contact hole, a second contact hole and a third contact hole of the second interlayer dielectric layer.

According to one or more example embodiments of the present disclosure, the connection wire may include a first connection wire, a second connection wire, and a third connection wire arranged spaced apart from one another, and the third connection wire may overlap the bending wire.

According to one or more example embodiments of the present disclosure, the third connection wire may be spaced apart from each of the first connection wire and the second connection wire.

According to one or more example embodiments of the present disclosure, the display panel may further include a second interlayer dielectric layer arranged between the bending wire and the first connection wire and between the bending wire and the second connection wire, the first connection wire may contact the bending wire through a first contact hole of the second interlayer dielectric layer, and the second connection wire may contact the bending wire through a second contact hole of the second interlayer dielectric layer.

According to one or more example embodiments of the present disclosure, the third connection wire may be arranged on the bending wire to contact the bending wire.

According to one or more example embodiments of the present disclosure, a first side surface of the first area and a second side surface of the second area may be inclined surfaces each having a predetermined slope.

According to one or more example embodiments of the present disclosure, the display panel may further include a first electrode arranged on the planarization layer, the bending wire may include a first layer and a second layer, and at least one of the first layer and the second layer may include a metal layer identical to a metal layer of the first electrode.

According to one or more example embodiments of the present disclosure, the planarization layer may include an organic material.

A display panel according to one or more example embodiments of the present disclosure may include a substrate including a first substrate and a second substrate spaced apart from each other by the groove; a circuit layer arranged on the first substrate and including a transistor; a planarization layer arranged on the first substrate and the groove; a pad portion arranged on the second substrate; a bending wire arranged on the planarization layer; and a connection wire connecting the pad portion and the bending wire.

According to one or more example embodiments of the present disclosure, insulating or dielectric layers disposed directly on electrodes of the transistor may be disposed on the first substrate and the second substrate without being disposed on the groove so that the insulating or dielectric layers may be absent from a bending area. For example, the insulating or dielectric layers may include the gate insulating layer, the first interlayer dielectric layer, and the second interlayer dielectric layer.

According to one or more example embodiments of the present disclosure, inorganic layers of the circuit layer may be disposed on the substrate excluding the groove so that the inorganic layers may be absent from a bending area. For example, the inorganic layers may include the gate insulating layer, the first interlayer dielectric layer, and the second interlayer dielectric layer.

According to one or more example embodiments of the present disclosure, metal layers of the circuit layer may be disposed on the first substrate without being disposed on the groove or disposed on the first substrate and the second substrate without being disposed on the groove. For example, the metal layers of the circuit layer may include some or all of the following electrodes: a gate electrode, a source electrode, a drain electrode, a first electrode, and a second electrode.

According to one or more example embodiments of the present disclosure, the bending wire may be separate and different from the connection wire.

The aspects to be achieved by the present disclosure, the means for achieving the aspects, and effects of the present disclosure described above do not specify essential features of the claims, and thus, the scope of the claims is not limited to the disclosure of the present disclosure.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure. The protective scope of the present disclosure should be construed based on the following claims, and all the technical concepts in the equivalent scope thereof should be construed as falling within the scope of the present disclosure.

What is claimed is:

1. A display device, comprising:
a display panel,
wherein the display panel comprises:
a groove;
a substrate including a first area and a second area spaced apart from each other by the groove;
a circuit layer arranged on the first area and including a transistor;
a planarization layer arranged on the first area and the groove;
a pad portion arranged on the second area;
a bending wire arranged on the planarization layer; and
a connection wire connected to the bending wire.

2. The display device of claim 1, wherein the bending wire includes a material different from a material of the connection wire.

3. The display device of claim 1, wherein the bending wire includes a first layer and a second layer, and
wherein a material of the first layer and a material of the second layer are different from each other.

4. The display device of claim 1, wherein the planarization layer arranged on the groove extends to overlap the second area.

5. The display device of claim 1, further comprising:
a pattern layer arranged on the bending wire,
wherein the pattern layer is made of an organic insulating material.

6. The display device of claim 5, wherein a width of the pattern layer is smaller than a length of the bending wire.

7. The display device of claim 5, wherein the pattern layer overlaps the groove.

8. The display device of claim 1, further comprising:
a coating layer arranged in the groove.

9. The display device of claim 1, wherein the connection wire includes a first connection wire that contacts one side of the bending wire and a second connection wire that contacts another side of the bending wire.

10. The display device of claim 9, further comprising:
a pattern layer arranged between the first connection wire and the second connection wire, and
wherein the first connection wire and the second connection wire are connected via the bending wire.

11. The display device of claim 9, further comprising:
a second interlayer dielectric layer arranged between the bending wire and the first connection wire and between the bending wire and the second connection wire,
wherein the first connection wire contacts the bending wire through a first contact hole of the second interlayer dielectric layer, and
wherein the second connection wire contacts the bending wire through a second contact hole of the second interlayer dielectric layer.

12. The display device of claim 1, wherein at least a portion of the connection wire is arranged on the bending wire.

13. The display device of claim 12, further comprising:
a pattern layer arranged on the connection wire,
wherein the pattern layer overlaps the groove.

14. The display device of claim 12, further comprising:
a second interlayer dielectric layer arranged between the bending wire and the connection wire,
wherein the connection wire contacts the bending wire through a first contact hole, a second contact hole and a third contact hole of the second interlayer dielectric layer.

15. The display device of claim 1, wherein the connection wire includes a first connection wire, a second connection wire, and a third connection wire arranged spaced apart from one another, and
wherein the third connection wire overlaps the bending wire.

16. The display device of claim 15, wherein the third connection wire is spaced apart from each of the first connection wire and the second connection wire.

17. The display device of claim 15, further comprising:
a second interlayer dielectric layer arranged between the bending wire and the first connection wire and between the bending wire and the second connection wire,
wherein the first connection wire contacts the bending wire through a first contact hole of the second interlayer dielectric layer, and
wherein the second connection wire contacts the bending wire through a second contact hole of the second interlayer dielectric layer.

18. The display device of claim 17, wherein the third connection wire is arranged on the bending wire to contact the bending wire.

19. The display device of claim 1, wherein a first side surface of the first area and a second side surface of the second area are inclined surfaces each having a predetermined slope.

20. The display device of claim 1, further comprising:
a first electrode arranged on the planarization layer,
wherein the bending wire includes a first layer and a second layer, and
wherein at least one of the first layer and the second layer includes a metal layer identical to a metal layer of the first electrode.

21. The display device of claim 1, wherein the planarization layer includes an organic material.

22. The display device of claim 1, further comprising a circuit board connected to the display panel,
wherein the pad portion is connected to the circuit board.

23. A display panel, comprising:
a substrate including a first substrate and a second substrate spaced apart from each other by a groove;
a circuit layer arranged on the first substrate and including a transistor;
a planarization layer arranged on the first substrate and the groove;
a pad portion arranged on the second substrate;
a bending wire arranged on the planarization layer; and
a connection wire connecting the pad portion and the bending wire.
